(19) United States
(12) Patent Application Publication
(10) Pub. No.: US 2006/0070951 A1
(43) Pub. Date: Apr. 6, 2006

(54) Microchip, solvent displacement method using the microchip, concentrating method, and mass spectrometry system

(76) Inventors: Masakazu Baba, Tokyo (JP); Toru Sano, Tokyo (JP); Kazuhiro Iida, Tokyo (JP); Hisao Kawaura, Tokyo (JP); Noriyuki Iguchi, Tokyo (JP); Wataru Hattori, Tokyo (JP); Hiroko Someya, Tokyo (JP); Minoru Asogawa, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 10/536,597

(22) PCT Filed: Nov. 28, 2003
(86) PCT No.: PCT/JP03/15256

§ 371 Date: May 26, 2005

(30) Foreign Application Priority Data
Nov. 29, 2002 (JP) 2002-349256

(51) Int. Cl. C02F 1/44; B01D 15/08

(52) U.S. Cl. 210/637; 210/635; 210/656

(57) ABSTRACT

A particular component in a sample is recovered in a high concentration and solvent-replaced. A separator 100 is placed on a microchip and includes a channel 112 for flowing the particular component. The channel 112 includes a sample feeding channel 300 as well as a filtrate discharge channel 302 and a sample recovering part 308 which are branched from the sample feeding channel 300. There is formed a filter 304 for preventing passage of the particular component, at the inlet of the filtrate discharge channel 302 from the sample feeding channel 300. Furthermore, there is formed a damming area (hydrophobic area) 306 for preventing entering of a liquid sample while allowing for passage of the liquid sample by applying an external force equal to or larger than a given level, at the inlet of the sample recovering part 308 from the sample feeding channel 300.

### BACKGROUND OF THE INVENTION

1. Field of the Invention

This invention relates to a microchip, methods for concentrating a particular component in a sample and for solvent displacement using such a microchip, and a mass spectrometry system.

2. Description of the Related Art

Proteomics has got a lot of attention as a promising research method in a post-genome age. In a proteomics study, a sample such as a protein is identified by, for example, mass spectrometry as a final stage. Prior to the stage, a sample is separated and pre-treated for, e.g., mass spectrometry. As a method for such sample separation, two-dimensional electrophoresis has been widely used. In two-dimensional electrophoresis, amphoteric electrolytes such as a peptide and a protein are separated at their isoelectric points and then further separated according to their molecular weights.

However, these separation methods generally require as much time as a whole day and night. Furthermore, they give a lower sample recovery and thus a relatively smaller amount of sample for analysis such as mass spectrometry. There has been, therefore, needs for improvement in this respect.

Micro-chemical analysis (μ-TAS) has been rapidly progressed, where chemical operations for a sample such as pre-treatment, reactions, separation and detection are conducted on a microchip. A separation and analysis procedure utilizing a microchip can reduce the amount of a sample to be used and thus environmental loading, allowing for analysis with higher sensitivity. It may significantly reduce a time for separation.

Patent Document 1 has described an apparatus comprising a microchip having a structure in which a trench and/or a reservoir are formed on a substrate for capillary electrophoresis. Patent Document 1: Japanese Laid-Open Patent Publication No. 2002-207031

### SUMMARY OF THE INVENTION

However, for preparing components after separation with a microchip as a sample for subsequent mass spectrometry, they must be further subjected to, for example, various chemical treatments, solvent replacement and desalting. There has not been developed technique in which these operations are conducted on a microchip.

In particular, when a sample contains salts in a buffer during analysis such as mass spectrometry, correct data cannot be obtained. In mass spectrometry, a sample is mixed with a matrix for mass spectrometry to be measured. When a mixing proportion of the sample to the matrix is low, an output may be too low to obtain satisfactory detection results.

In view of these problems, an objective of this invention is to provide a technique whereby a particular component in a sample is concentrated to be recovered at a higher concentration. Another objective of this invention is to provide a technique whereby a solvent is replaced while maintaining a particular component in a sample at a higher concentration. A further objective of this invention is to provide a technique whereby impurities such as salts in a sample are removed while maintaining a particular component in a sample at a higher concentration. Another objective of this invention is to provide a technique whereby these processes are conducted on a microchip.

According to this invention, there is provided a microchip on a substrate, comprising a channel for a liquid sample containing a particular component and a sample feeding part in the channel, wherein the channel is branched into a first channel and a second channel, an inlet of the first channel from the sample feeding part has a filter for preventing passage of the particular component, and an inlet of the second channel from the sample feeding part has a damming area preventing passage of the liquid sample while permitting the liquid sample to pass when an external force equal to or larger than a given level is applied.

The filter herein has a plurality of pores having a size sufficiently small to prevent passage of the particular component. The filter may be, for example, a plurality of pillars aligned at intervals of several ten to several hundred nanometers. Alternatively, the filter may be a porous film with a pore size of about several nanometers prepared by firing aluminum oxide, an aqueous solution of sodium silicate (water glass) or colloidal particles and a polymer gel film prepared by gelling a polymer sol. Alternatively, the filter may prevent passage of component by its charge rather than its molecular size.

Such a configuration may allow a particular component to be concentrated in the filter surface and removed from the second channel. Alternatively, for removing the particular component from the second channel, a solvent other than that in an original sample may be used for solvent replacement.

In the microchip of this invention, a damming area may be a lyophobic area. As used herein, a lyophobic area refers to an area having a less affinity for a liquid in a sample. When a liquid in a sample is a hydrophilic solvent, a damming area may be a hydrophobic area. Alternatively, when providing a coating over the microchip, an area corresponding to the coating may be lyophobic to achieve comparable effects. A lyophobicity of the lyophobic area to a solution may be controlled by selecting the type of a material for the lyophobic area, a shape of a lyophobic part in the lyophobic area and so on.

In the first channel in the microchip of this invention, a liquid sample which has passed through a filter may move by capillary D action. Thus, a liquid fed into the channel may spontaneously flow into the first channel.

In the microchip of this invention, the first channel may further comprise an inflow stopper provided at downstream of the filter for preventing a liquid from flowing into the first channel. The inflow stopper may be a valve closing a silicone tube connected to the end of the first channel or a reservoir capable of storing a predetermined amount of liquid which is formed at the end of the first channel.

In the microchip of this invention, the inflow stopper can prevent a liquid from flowing into the first channel when a predetermined amount of liquid enters the first channel.

The microchip of this invention may further comprise external force applying means for applying an external force to a liquid sample flowing a channel. The external force applying means can apply an external force to a sample such that when inflow of a liquid into the first channel is stopped by the inflow stopper, the liquid sample flows over the hydrophobic area into the second channel. The external force applying means may be pressurizing means. At the end of the second channel, there may be provided a recovering part for a desired component.

There is also provided a process for concentrating a particular component in a liquid sample using any of the microchips described above, comprising the steps of applying an external force enough to introduce the liquid sample containing the particular component and a solvent into a sample feeding part but not enough for the liquid sample to pass through the damming area; applying an external force comparable to that applied in the step of introducing the liquid sample to the sample feeding part to introduce the solvent or another solvent into the sample feeding part for a given period; and stopping the flow of the liquid into the first channel.

In the step of stopping the flow of the liquid into the first channel in the concentration process of this invention, an external force larger than that in any other steps may be applied.

There is also provided a process for replacing a solvent in a liquid sample containing a particular component using any of the microchips described above, comprising the steps of applying an external force enough to introduce the liquid sample containing the particular component and a first solvent into a sample feeding part but not enough for the liquid sample to pass through the damming area; applying an external force comparable to that applied in the step of introducing the liquid sample to the sample feeding part to introduce a solvent other than the first solvent into the sample feeding part for a given period; and stopping the flow of the liquid into the first channel.

Thus, after filtrating the particular component in the first solvent by the filter, the particular component may be washed with the second solvent, so that smaller molecules such as the first solvent and salts may be removed. Furthermore, since the particular component is concentrated on the filter, a highly-concentrated sample can be recovered.

In the step of preventing a liquid from flowing into the first channel in the concentrating process of this invention, an external force larger than that in any other steps may be applied.

According to another aspect of this invention, there is provided a microchip on a substrate, comprising a channel for a liquid sample containing a particular component and a plurality of discharge channels along the sidewall of the channel, wherein the discharge channels prevent passage of the particular component. The discharge channels may be capillaries through which only smaller molecules such as a solvent and salts can pass. Alternatively, the channel can have a filter in its connecting part. Such a configuration allows a particular component in a sample to be concentrated as the sample flows in the channel. There is also provided a process for concentrating a particular component in a liquid sample using such a microchip.

This invention also provides a microchip on a plate, comprising a channel for a liquid sample containing a particular component and a filter disposed to block the flow in the channel for preventing passage of the particular component, wherein the channel comprises a sample feeding part and a sample recovering part in one side and a solvent feeding part in the other side.

The filter herein has a plurality of pores having a size sufficiently small to prevent passage of the particular component. The filter may be, for example, a plurality of pillars aligned at intervals of several ten to several hundred nanometers. Alternatively, the filter may be a porous film with a pore size of about several nanometers prepared by firing aluminum oxide, an aqueous solution of sodium silicate (water glass) or colloidal particles and a polymer gel film prepared by gelling a polymer sol. Alternatively, the filter may prevent passage of component by its charge rather than its molecular size.

Such a configuration may allow a particular component to be concentrated in the filter surface and a sample can be recovered at a higher concentration by introducing a solvent from the other side of the channel. Alternatively, when introducing the solvent from the other side of the channel, a solvent other than that in the original sample can be used to replace a solvent.

The microchip of this invention may further comprise a discharging part disposed at a position other than the solvent feeding part in the other side of the filter, from which the liquid sample passing through the filter is discharged.

In the discharging part in the microchip of this invention, the liquid sample passing through the filter may move by capillary action.

In the microchip of this invention, the solvent feeding part may comprise a damming area preventing a liquid from entering from the direction of the filter while facilitating discharge of the liquid toward the filter.

In the microchip of this invention, the sample feeding part may comprise a damming area preventing a liquid from entering from the direction of the filter while facilitating discharge of the liquid toward the filter.

In the microchip of this invention, the damming area may be a lyophobic area. As used herein, a lyophobic area refers to an area having a less affinity for a liquid in a sample. When a liquid in a sample is a hydrophilic solvent, a damming area may be a hydrophobic area. Alternatively, when providing a coating over the microchip, an area corresponding to the coating may be lyophobic to achieve comparable effects.

This invention also provides a process for concentrating a particular component in a liquid sample using any of the microchips described above, comprising the steps of introducing the liquid sample containing the particular component and a solvent into a sample feeding part and recovering the particular component from the sample recovering part by introducing another solvent from a solvent feeding part.

The process for replacing a solvent of this invention may further comprise the step of introducing one of the solvents from the sample feeding part, between the steps of introducing and recovering the liquid sample. Thus, the particular component concentrated on the filter may be washed with a solvent.

There is also provided a process for replacing a solvent in a liquid sample containing a particular component using a microchip of this invention, comprising the steps of introducing the liquid sample containing the particular component and a first solvent into a sample feeding part, and recovering the particular component from the sample recovering part by introducing a second solvent other than the first solvent from a solvent feeding part.

The process for replacing a solvent of this invention may further comprise the step of introducing the second solvent from the sample feeding part between the steps of introducing and recovering the liquid sample. Thus, the particular component concentrated on the filter may be washed with a solvent.

This invention also provide a microchip on a substrate, comprising a channel including a first channel in which a liquid sample containing a particular component flows and a second channel extending along the first channel, and a filter intervening between the first and the second channels for preventing passage of the particular component, wherein the first channel comprises a sample feeding part for introducing the liquid sample upstream in the flowing direction and the second channel comprises a substituting solvent feeding part at a position corresponding to the downstream in the flowing direction in the first channel.

The filter herein has a plurality of pores having a size sufficiently small to prevent passage of the particular component. The filter may be, for example, a plurality of pillars aligned at intervals of several ten to several hundred nanometers. Alternatively, the filter may be a porous film with a pore size of about several nanometers prepared by firing aluminum oxide, an aqueous solution of sodium silicate (water glass) or colloidal particles and a polymer gel film prepared by gelling a polymer sol.

Thus, by disposing the filter intervening between the parallel channels, an area of the filter may be increased to prevent clogging of the filter, and further to increase a separation flow rate. Furthermore, since the particular component is washed with the second solvent in the course of passage of the particular component in the sample through the first channel, impurities such as the first solvent and salts adhering to the particular component can be removed. In addition, such a configuration allows for continuous processing.

The microchip of this invention may further comprise D external force applying means which applies an external force to the first and the second channels in different directions.

In the microchip of this invention, the external force applying means can apply a larger external force to the first channel than to the second channel.

Thus, the particular component in the sample flowing through the first channel is concentrated as it moves in the first channel, so that the sample may be concentrated while the solvent is replaced. Thus, since a desired component may be obtained at a higher concentration, subsequent analyses may be conducted with a higher accuracy.

This invention also provides a microchip on a substrate, comprising a channel for a liquid sample containing a particular component and an electrode formed in the channel, wherein the electrode has a charge having a different polarity from that of the particular component.

For example, when the particular component is a protein, the electrode may be positively charged because the protein has a negative charge. The electrode may be comprised of a plurality of pillars. Thus, a surface area may be increased to recover a large amount of the component. Herein, the plurality of electrodes preferably have a shape such that these may not electrically affect to each other. When disposing the plurality of electrodes, they may be formed such that each electrode can be individually controlled. Thus, for example, all of the electrodes may be first charged with a polarity different from that of the particular component to recover the particular component. Then, while maintaining the polarity of one of the electrodes, the other electrodes are made neutral or charged with the same polarity as the particular component, to gather the particular component in one electrode. Therefore, the particular component may be more efficiently concentrated.

This invention also provides a process for replacing a solvent in a liquid sample using a separator comprising a first and a second channels for a liquid sample containing a particular component and a filter intervening between the channels, comprising the step of moving the liquid sample containing the particular component and a first solvent in the first channel in a first direction and simultaneously moving a second solvent in the second channel in a direction different from the first direction, wherein a ratio of the second solvent to the first solvent increases as the liquid sample is moved in the first channel.

In the process for replacing a solvent of this invention, an external force applied for moving the liquid sample containing the particular component and the first solvent in the first channel in the first direction can be larger than an external force for moving the second solvent in the second channel in a direction different from the first direction, to concentrate the particular component in the downstream of the first channel.

This invention also provides a process for replacing a solvent in a liquid sample containing a particular component using a channel comprising an electrode, comprising the steps of feeding the liquid sample containing the particular component and a first solvent into the channel while charging the electrode with an opposite polarity to the particular component; feeding a second solvent into the channel while maintaining the charge of the electrode; and discharging the electrode and recovering the particular component together with the second solvent.

In the process for replacing a solvent of this invention, the electrode may have a charge with the same polarity as the particular component in the step of recovery.

Although a microchip having the functions of concentrating a particular component and replacing a solvent has been described, the microchip may further have the functions of, for example, purification, separation, pre-treatment (except concentration and solvent replacement) and drying of a sample. Thus, it may be used in a mass spectrometer as it is.

This invention also provides a mass spectrometry system comprising separation means for separating a biological sample by a molecular size or properties; pre-treatment means for pretreating the sample separated by the separation means including enzymatic digestion; drying means for drying the pretreated sample; and mass spectrometry means for analyzing the dried sample by mass spectrometry, wherein the pretreatment means comprises any of the microchips described above. Herein, the biological sample may be extracted from an organism or synthesized.

This invention also provides a mass spectrometry system comprising pretreatment means for separating a biological sample by a molecular size or properties while pretreating the sample for preparation for enzymatic digestion; means for enzymatically digesting the pretreated sample; drying means for drying the enzymatically digested sample; and mass spectrometry means for analyzing the dried sample by mass spectrometry, wherein the pretreatment means comprises any of the microchips described above.

### BRIEF DESCRIPTION OF THE DRAWINGS

The above and other objectives, features and advantages will be more clearly understood with reference to embodiments described below and the accompanied drawings.

FIG. 1 shows a part of a concentrating apparatus in an embodiment of this invention.

FIG. 2 shows a part of a concentrating apparatus in an embodiment of this invention.

FIG. 3 shows an example of a hydrophobic area in an embodiment of this invention.

FIG. 4 shows another example of a concentrating apparatus.

FIG. 5 shows a configuration of a solvent-replacing apparatus in an embodiment of this invention.

FIG. 6 schematically shows a solvent-replacing apparatus in an embodiment of this invention.

FIG. 7 shows a solvent-replacing apparatus in an embodiment of this invention.

FIG. 8 is a cross-sectional view of the solvent-replacing apparatus in FIG. 7.

FIG. 9 is a process cross-sectional view showing a method for manufacturing a solvent-replacing apparatus in an embodiment of this invention.

FIG. 10 shows another example of an electrode.

FIG. 11 shows another example of an electrode.

FIG. 12 shows a microchip formed on a substrate.

FIG. 13 is a flow chart illustrating a concentrating apparatus in an embodiment of this invention.

FIG. 14 is a flow chart illustrating a concentrating apparatus in an embodiment of this invention.

FIG. 15 is a flow chart illustrating a concentrating apparatus in an embodiment of this invention.

FIG. 16 schematically shows a mass spectrometer.

FIG. 17 is a block diagram of a mass spectrometry system including a separator or a solvent-replacing apparatus in this embodiment.

FIG. 18 shows an example using a polymer gel film as a filter.

FIG. 19 is a flow chart showing a manufacturing process for a filter.

FIG. 20 is a flow chart showing a manufacturing process for a filter.

FIG. 21 shows a filter manufactured by the manufacturing process shown in FIGS. 19 and 20.

FIG. 22 schematically shows a solvent-replacing apparatus according to this invention as a microchip.

FIG. 23 shows a joint structure.

FIG. 24 shows another joint structure.

FIG. 25 is a detailed drawing of a filter in a solvent-replacing apparatus having the structure shown in FIG. 22.

FIG. 26 is a plan view showing an example of the hydrophobic area in FIG. 1.

FIG. 27 shows an example of the filtrate discharge channel in FIG. 1.

FIG. 28 shows an example of a concentrating apparatus in an embodiment of this invention.

FIG. 29 shows another example of an electrode.

FIG. 30 schematically shows a chip structure in Example.

FIG. 31 shows a structure of a pillar in Example.

FIG. 32 shows a chip structure in Example.

FIG. 33 shows a concentrating/replacing apparatus in Example to which water is introduced.

FIG. 34 shows a concentrating part in Example in which a DNA is deposited.

FIG. 35 shows a sample recovering part in Example in which a DNA is flowing.

### DETAILED DESCRIPTION OF THE INVENTION

For analysis of a biological material, for example, the following pretreatments are conducted.

(i) separation of cells from the other components and concentration thereof;

(ii) separation and concentration of solids (cytoplasmic membrane fragments, mitochondria and endoplasmic reticula) and a liquid fraction (cytoplasma) among components obtained by cell destruction;

(iii) separation and concentration of high molecular-weight components (DNA (deoxyribonucleic acid), RNA (ribonucleic acid), proteins, sugar chains) and low molecular-weight components (steroids, dextrose, etc.) among the components in the liquid fraction; and

(iv) separation decomposition products from unchanged components after macromolecule decomposition.

In this invention, besides the above pretreatments, solvent replacement is also conducted for, e.g., a subsequent processing.

In this invention, a sample to be concentrated or solvent-replaced is a sample in which a given component is dissolved or dispersed in a solvent (carrier).

### FIRST EMBODIMENT

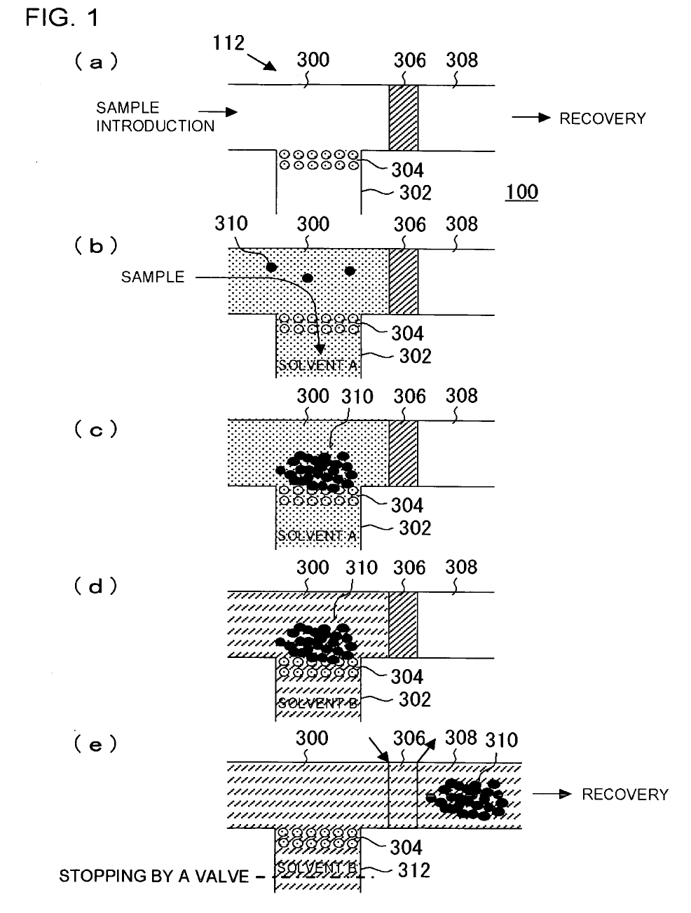

FIG. 1 shows a part of a concentrating apparatus according to first embodiment of this invention.

As shown in FIG. 1(a), the concentrating apparatus 100 includes a sample feeding channel 300, a filtrate discharge channel 302, a sample recovering part 308, a filter 304 intervening between the sample feeding channel 300 and the filtrate discharge channel 302, and a hydrophobic area 306 intervening between the sample feeding channel 300 and the sample recovering part 308.

The filter 304 has pores with an adequately small size to prevent passage of a particular component. The pore size of the filter 304 may be appropriately selected, depending on the type of the particular component to be concentrated. The filter 304 may be a porous film prepared by firing aluminum oxide, an aqueous solution of sodium silicate (water glass) or colloidal particles, a polymer gel film prepared by gelling a polymer sol, or a number of pillars. Processes for preparing these will be described later.

The hydrophobic area 306 can prevent a liquid from entering the sample recovering part 308 and prevent a solvent introduced into the sample feeding channel 300 from flowing into the sample recovering part 308.

The hydrophobic area 306 may be formed by hydrophobilizing the surface of a hydrophilic channel 112. Hydrophobilization may be conducted by forming a hydrophobic film on the surface of the channel 112 by an appropriate method such as spin coating, spraying, dipping and vapor deposition using a silan compound such as a silan coupling agent and a silazane (hexamethylsilazane, etc.). The silan coupling agent may be selected from those having a hydrophobic group such as a thiol group.

Hydrophobilization may be conducted by printing technique such as stamping and ink-jet technique. In stamping, a PDMS (polydimethylsiloxane) resin is used. The PDMS resin is prepared by polymerizing a silicone oil and, even after resinification, its intermolecular spaces are filled with the silicone oil. Therefore, when the PDMS resin is contacted with the surface of the channel 112, the contact area becomes highly hydrophobic and thus repels water. Utilizing the effect, a PDMS resin block having a concave at a position corresponding to the hydrophobic area 306 is contacted as a stamp, to form the hydrophobic area 306. In ink-jet technique, a silicone oil is used as an ink in ink-jet printing to form the hydrophobic area 306. Thus, a fluid cannot pass through a hydrophobilized area, so that the flow of a sample can be blocked.

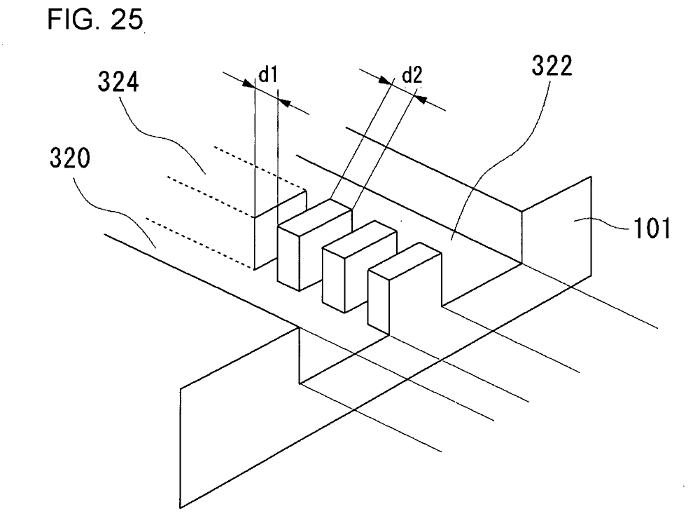

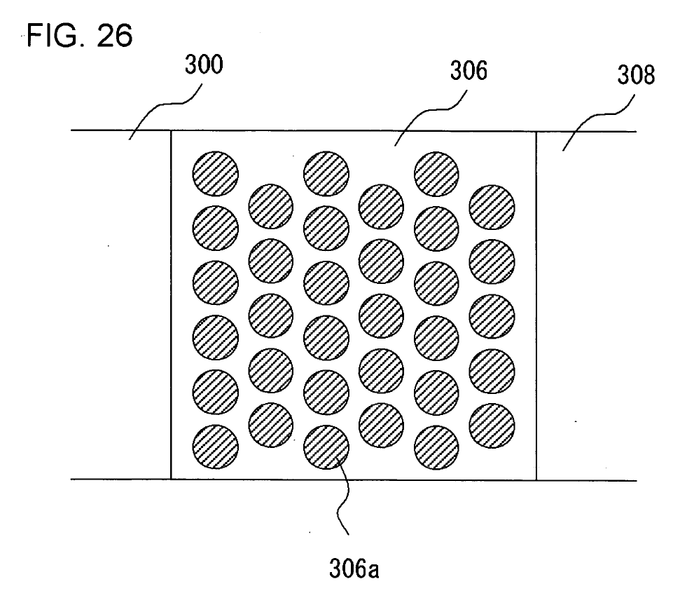

A degree of hydrophobicity of the hydrophobic area 306 may be appropriately controlled by selection of a material and also by selecting a shape of a hydrophobic part in the hydrophobic area 306. FIG. 26 is a plan view showing an example of the hydrophobic area 306. In the hydrophobic area 306, a plurality of hydrophobic parts 306a are regularly aligned at a substantially regular intervals. In the hydrophobic area 306, the area other than the hydrophobic part 306a is hydrophilic. Thus, movement of a solvent from the sample feeding channel 300 may be more facilitated in comparison with the case where the whole surface of the hydrophobic area 306 is hydrophobilized. As the hydrophobic parts 306a are closer, hydrophobicity becomes higher. Thus, a shape of the hydrophobic part in the hydrophobic area 306 may be properly designed to control damming function of the hydrophobic area 306 as appropriate.

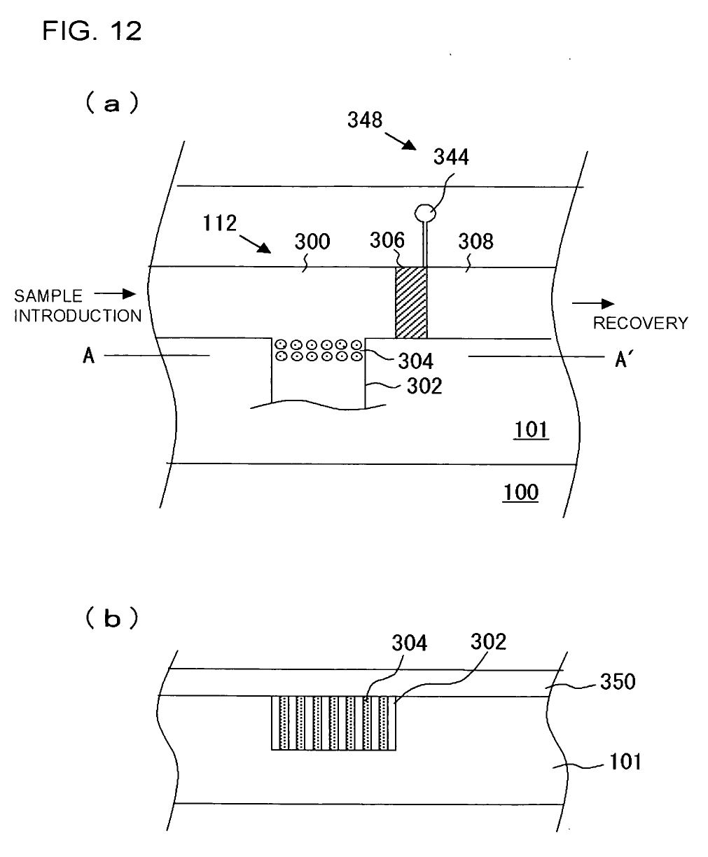

A concentrating apparatus 100 in this embodiment is a microchip formed on a substrate 101 as shown in FIG. 12. FIG. 12(a) is a plan view showing a part of the substrate 101 and FIG. 12(b) is a cross-sectional view taken on line A-A′ of FIG. 12(a).

As shown in FIG. 12(a), a fluid switch 348 including a priming-water injection port 344 is provided on the side of the hydrophobic area 306. As described above, there is provided the hydrophobic area 306 between the sample feeding channel 300 and the sample recovering part 308, so that a sample does not flow into the sample recovering part 308. However, when feeding priming water from the priming-water injection port 344, it may be a fluid switch to feed the sample in a direction from the sample feeding channel 300 to the sample recovering part 308. Here, the priming-water injection port 344 is formed with a predetermined volume such that water is introduced in the port from the outside. When water is fed D into the priming-water injection port 344 thus formed at a constant flow rate, water begins to flow from the priming-water injection port 344 to the hydrophobic area 306 after a certain period. A volume of the priming-water injection port 344 and a flow rate of water to be introduced may be appropriately selected such that after a sample in solvent A is filtrated by a filter 304 and washed with solvent B, the sample flows over the hydrophobic area 306 into the sample recovering part 308. The filtrate discharge channel 302 is formed such that a liquid moves by capillary action.

Furthermore, as shown in FIG. 12(b), a coating material 350 is disposed over the substrate 101. As described above, the hydrophobic area 306 may be formed on the surface of the channel 112 on the substrate 101, but comparable effects may be achieved by hydrophobilizing the coating material 350. Here, when disposing the coating material 350 over the substrate 101, a position in the coating material 350 corresponding to the hydrophobic area 306 may be hydrophobilized.

Again, referring to FIG. 1, a sample containing a component 310 and solvent A is introduced into the concentrating apparatus 100 thus configured as shown in FIG. 1(b). The component 310 introduced is, for example, a protein. The concentrating apparatus 100 in this embodiment may be used in pretreatment for, e.g., MALDI-TOFMS. Herein, into the concentrating apparatus 100 is fed a sample after cleavage of an intramolecular disulfide bond in a solvent such as acetonitrile or after molecular-weight reduction of a protein in a buffer. Solvent A is, for example, an organic solvent such as acetonitrile or a salt-containing solution such as a phosphate buffer.

After the component 310 in solvent A is introduced in the sample feeding channel 300, solvent A passes through the filter 304 into a filtrate discharge channel 302 by capillary action while the component 310 is deposited on the surface of the filter 304. Here, the sample is introduced into the sample feeding channel 300 by applying a pressure not sufficient for solvent A to pass over the hydrophobic area 305 into the sample recovering part 308, using, for example, a pump.

When the sample flows as described above, the component 310 is concentrated on the surface of the filter 304 as shown in FIG. 1(c).

Subsequently, as shown in FIG. 1(d), solvent B is introduced into the sample feeding channel 300 for adequately washing out solvent A adhering to the component 310. Solvent B may be, for example, a buffer solution or distilled water or distilled water when solvent A is acetonitrile or a buffer solution, respectively. Thus, in addition to solvent A adhering to the component 310, impurities such as salts contained in the sample can be also removed.

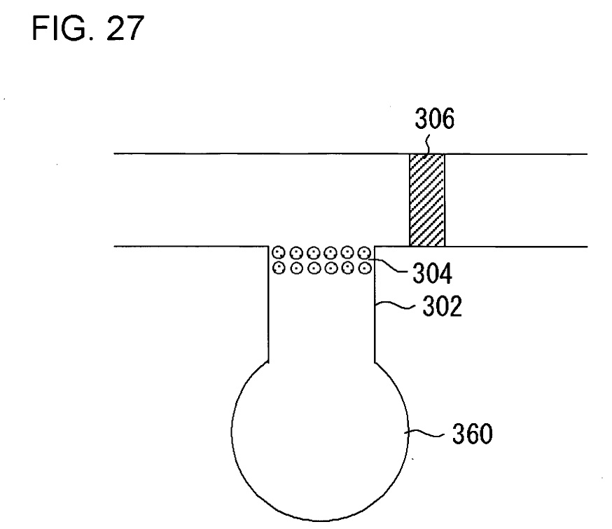

After washing for a certain period, as shown in FIG. 1(e), inflow of the liquid into the filtrate discharge channel 302 is stopped by an inflow stopper 312 provided at the end of the filtrate discharge channel 302 distant from the filter 304. The inflow stopper 312 may be selected from various valves. For example, it may be a silicone tube connected to the end of the filtrate discharge channel 302, which is closed by, for example, a solenoid valve. Alternatively, as shown in FIG. 27, a reservoir 360 with a given volume may be provided at the end of the filtrate discharge channel 302. The amount of solvent A in a sample introduced into the sample feeding channel 300 and the amount of solvent B required for washing the component 310 may be preliminarily detected so that the reservoir 360 can be formed to accommodate the corresponding amount. Thus, when the reservoir 360 is filled with solvents, inflow of a liquid into the filtrate discharge channel 302 is stopped.

While stopping inflow of the liquid into the filtrate discharge channel 302, a pressure applied to the sample feeding channel 300 may be increased and/or priming water may be fed from the fluid switch 348 shown in FIG. 12(a) to recover the component 310 concentrated on the surface of the filter 304 together with solvent B from the sample recovering part 308.

In the concentrating apparatus 100 in this embodiment, the filter capable of preventing passage of the particular component may be used to concentrate the particular component to a higher concentration. Thus, for example, in MALDI-TOFMS, a protein molecule may be mixed with a matrix for MALDI-TOFMS at a relatively higher concentration. Furthermore, the particular component may be washed with a replacing solvent so that desalting can be also conducted. Thus, MALDI-TOFMS may be more accurately conducted. In the concentrating apparatus 100 in this embodiment, the particular component can be recovered at a higher concentration without impurities. The sample is, therefore, suitable not only for MALDI-TOFMS but also for a variety of reactions. Although replacement of solvent A with solvent B has been described, the concentrating apparatus 100 in this embodiment may be exclusively used, besides solvent replacement, for concentrating the particular component.

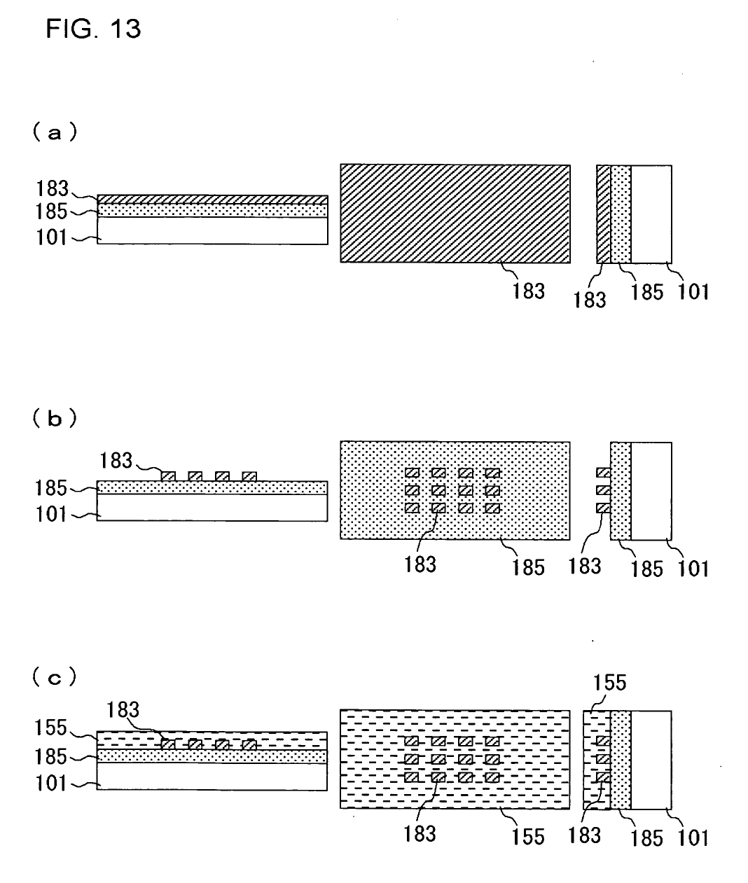

There will be described a process for manufacturing the concentrating apparatus 100 in this embodiment with reference to FIGS. 13, 14 and 15. Here, there will be described a case where a number of pillars 105 are used as a filter 304. The pillars may have a shape including cylindrical bodies such as a cylinder, a cylindroid and a pseud-cylinder; pyramises such as a cone, an elliptic cone and a triangular pyramid; prisms such as a triangular prism and a quadratic prism; stripe protrusions; and other various shapes. The channel 112 and the filter 304 may be formed on the substrate 101 by, but not limited to, etching the substrate 101 in a given pattern shape.

In sub-figures in each figure, the middle is a plan view and the right and the left are cross-sectional views. In this process, the cylinders 105 are formed by the use of electron beam lithography using a calix arene as a resist for fine processing. The following is an exemplary molecular structure of a calix arene. A calix arene is used as a resist for electron beam exposure and may be suitably used as a resist for nano processing.

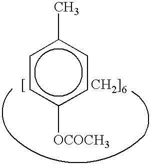

Herein, a substrate 101 is a silicon substrate with an orientation of (100). First, as shown in FIG. 13(a), on the substrate 101 are formed a silicon oxide film 185 and a calix arene electron-beam negative resist 183 in sequence. Thicknesses of the silicon oxide film 185 and the calix arene electron-beam negative resist 183 are 40 nm and 55 nm, respectively. Then, an area to be the pillars 105 is exposed to an electron beam (EB). The product is developed with xylene and rinsed with isopropyl alcohol. By this step, the calix arene electron-beam negative resist 183 is patterned as shown in FIG. 13(b).

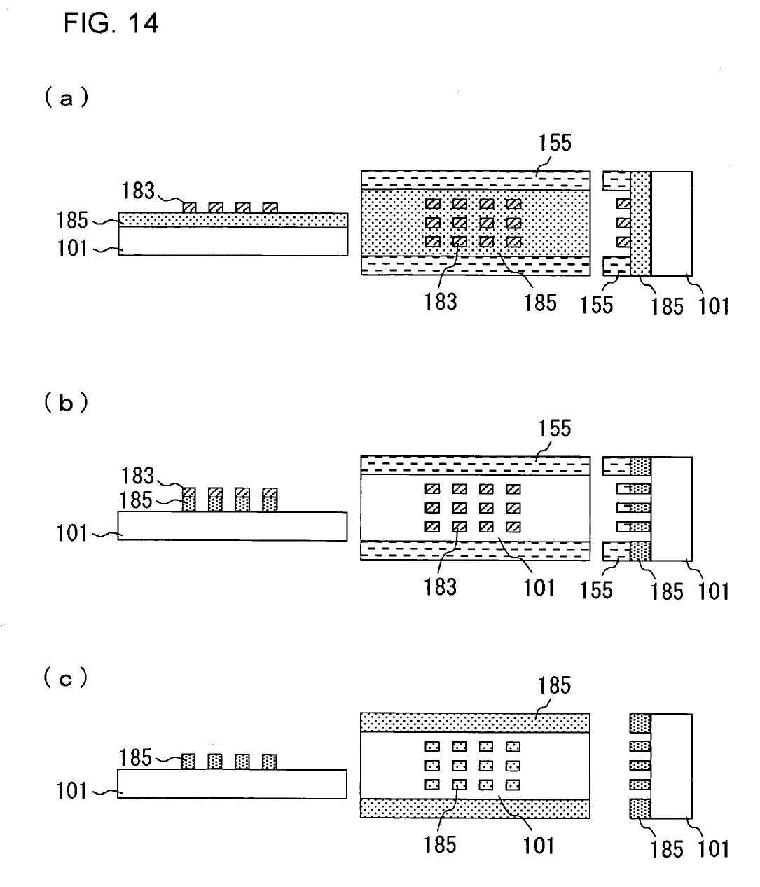

Next, a positive photoresist 155 is applied to the whole surface (FIG. 13(c)). Its thickness is 1.8 μm. Then, the product is developed by mask exposure such that the area to be the channels 112 is exposed (FIG. 14(a)).

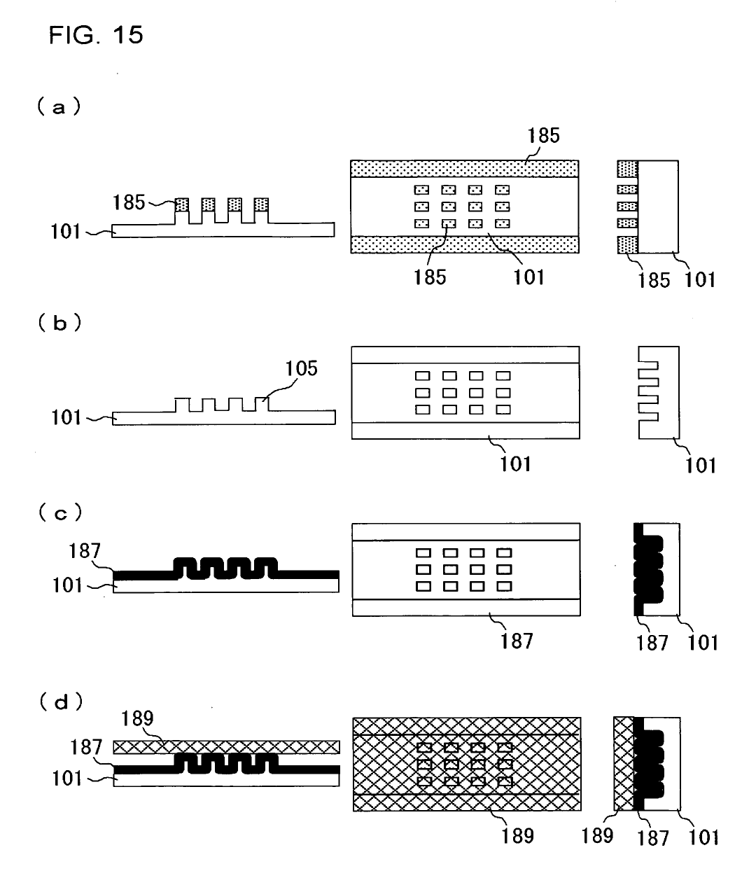

Then, the silicon oxide film 185 is RIE-etched using a mixed gas of CF₄ and CHF₃ (FIG. 14(b)). After removing the resist by washing with an organic solvent mixture of acetone, an alcohol and water, the substrate is subjected to oxidation plasma treatment (FIG. 14(c)). Then, the substrate 101 is ECR-etched using HBr gas. A height of the step in the silicon substrate after etching (or a height of the cylinders) is 400 nm (FIG. 15(a)). Next, the substrate is wet etched with BHF-buffered hydrofluoric acid to remove the silicon oxide film (FIG. 15(b)). Thus, the channel (not shown) and the cylinders 105 are formed on the substrate 101.

Herein, it is preferable to make the surface of the substrate 101 hydrophilic after the step in FIG. 15(b). By making the surface of the substrate 101 hydrophilic, a sample liquid can be smoothly guided into the channel 112 and the cylinders 105. In particular, in the filter 304 (FIG. 1) where the channel is finer by the cylinders 105, hydrophilization of the channel surface may promote introduction of a sample liquid by capillary action to efficiently concentrate a component.

After the step in FIG. 15(b), the substrate 101 is heated in a furnace to form a silicon thermal oxide film 187 (FIG. 15(c)). Herein, heating conditions are selected such that a thickness of the oxide film becomes 30 nm. Forming the silicon thermal oxide film 187 can eliminate difficulty in introducing a liquid into a separating apparatus. Then, a coating 189 is electrostatically joined. After sealing, a concentrating apparatus is formed (FIG. 15(d)).

When using a plastic material for the substrate 101, a known method suitable for the type of the material for the substrate 101 may be employed, including etching, press molding using a mold such as emboss molding, injection molding and photo-curing.

Again, when using a plastic material for the substrate 101, the surface of the substrate 101 is preferably hydrophilized. By hydrophilizing the surface of the substrate 101, a sample liquid can be smoothly introduced into the channel 112 and the cylinders 105. In particular, in the filter 304 including the pillars 105, hydrophilization of the surface may promote introduction of a sample liquid by capillary action to efficiently effect concentration.

Surface treatment for hydrophilization may be, for example, conducted by applying a coupling agent having a hydrophilic group to the side wall of the channel 112. A coupling agent having a hydrophilic group may be a silane coupling agent having an amino group; for example N-β(aminoethyl)γ-aminopropylmethyldimethoxysilane, N-β(aminoethyl)γ-aminopropyltrimethoxysilane, N-β(aminoethyl)γ-aminopropyltriethoxysilane, γ-aminopropyltrimethoxysilane, γ-aminopropyltriethoxysilane and N-phenyl-γ-aminopropyltrimethoxysilane. These coupling agents may be applied by an appropriate method such as spin coating, spraying, dipping and vapor deposition.

Furthermore, the channel 112 may be subjected to antisticking treatment for preventing sample molecules from sticking on the channel wall. As antisticking treatment, for example, a substance having a similar structure to that of a phospholipid constituting a cell wall may be applied to the sidewall of the channel 112. When the sample is a biological component such as a protein, such a treatment may not only prevent degeneration of the component but also minimize nonspecific adsorption of the particular component on the channel 112, resulting in an improved recovery. For hydrophilization and antisticking treatment, for example, LIPIDURE® (NOF Corporation) may be used. Herein, LIPIDURE® is dissolved in a buffer such as TBE buffer to 0.5 wt %. The channel 112 is filled with the solution and left for several minutes to treat the inner wall of the channel 112. Then, the solution is purged by, for example, an air gun to dry the channel 112. As an alternative example of antisticking treatment, a fluororesin may be applied to the sidewall of the channel 112.

### SECOND EMBODIMENT

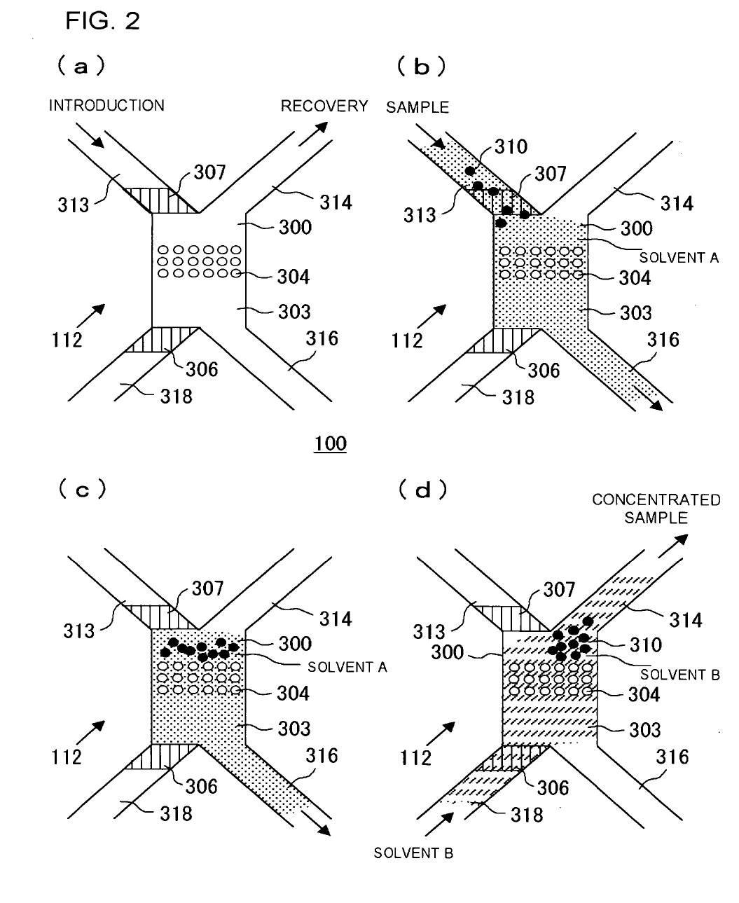

FIG. 2 shows a part of a concentrating apparatus 100 in second embodiment of this invention. In this embodiment, the concentrating apparatus 100 may be also a microchip. As shown in FIG. 2(a), in this embodiment, the channel 112 includes a sample feeding channel 300, a solvent feeding channel 303, a filter 304, a sample feeding part 313, a sample recovering part 314, a filtrate discharging part 316 and a solvent feeding part 318. There are provided a hydrophobic area 307 between the sample feeding part 313 and the sample feeding channel 300, and a hydrophobic area 306 between the solvent feeding part 318 and the solvent feeding channel 303, respectively. In this embodiment, components analogous to the concentrating apparatus 100 in first embodiment described with reference to FIG. 1 are denoted by the same symbols and further description is omitted as appropriate.

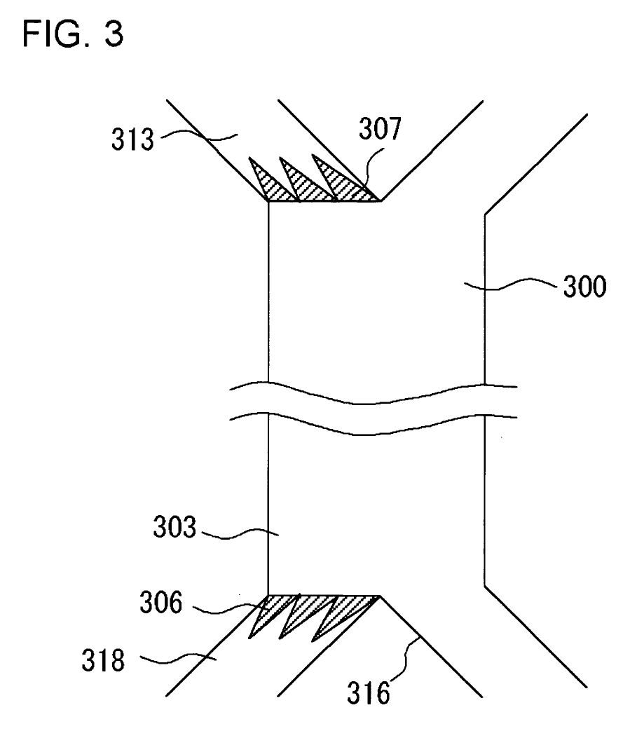

FIG. 3 shows an example of the hydrophobic area 306 and hydrophobic area 307 in this embodiment. As shown in this figure, the hydrophobic area 306 is tapered such that it gradually expands in the direction from the solvent feeding part 318 to the solvent feeding channel 303. Thus, a liquid can easily move in the direction from the solvent feeding part 318 to the solvent feeding channel 303, while being blocked in the direction from the solvent feeding channel 303 to the solvent feeding part 318. The hydrophobic area 307 is also tapered such that it gradually expands in the direction from the sample feeding part 313 to the sample feeding channel 300. Thus, a liquid can easily move in the direction from the sample feeding part 313 to the sample feeding channel 300 while being blocked in the direction from the sample feeding channel 300 to the solvent feeding part 313. Again, as described in first embodiment with reference to FIG. 26, the materials of the hydrophobic area 306 and the hydrophobic area 307 and the shape of the hydrophobic part may be selected as appropriate. In this embodiment, as described in first embodiment with reference to FIG. 12(a), the hydrophobic area 306 and the hydrophobic area 307 may include a fluid switch 348. Furthermore, the sample feeding part 313, the sample recovering part 314, the solvent feeding part 318 and the filtrate discharging part 316 may be connected to the outside via a silicone tube, a syringe or the like. Inflow and outflow of a sample or solvent may be controlled by, for example, an external pump or solenoid valve.

Referring back to FIG. 2, as shown in FIG. 2(b), a sample is introduced from the sample feeding part 313. The sample is herein a component 310 in solvent A as described in first embodiment. After being fed into the sample feeding channel 300, solvent A passes through the filter 304 into the solvent feeding channel 303. Here, since the inlet of the solvent feeding part 318 has the hydrophobic area 306, solvent A is discharged from the filtrate discharging part 316 without entering the solvent feeding part 318. Thus, as shown in FIG. 2(c), the component 310 in the sample is deposited and then concentrated on the surface of the filter 304.

Then, when solvent B as a replacing solvent is introduced from the solvent feeding part 318, solvent B passes through the filter 304. The component 310 deposited on the surface of the filter 304 is eluted with solvent B from the sample recovering part 314. Thus, the solvent for the component 310 can be replaced and the component 310 can be recovered by concentration.

In the above embodiment, the inlet of each solvent feeding part 318 includes the hydrophobic area 306. However, instead of forming the hydrophobic area 306, inflow of solvent A may be prevented by applying an air pressure to the solvent feeding part 318 during introduction of solvent A. Likewise, during introducing solvent B from the solvent feeding part 318, an air pressure may be applied to the sample feeding part 313 to prevent solvent B from entering the sample feeding part 313.

Furthermore, although not shown in the figure, after concentrating the component 310 on the surface of the filter 304 (FIG. 2(c)), solvent B can be introduced from the sample feeding part 313 to wash out solvent A adhering to the surface of the component 310 and other compounds such as salts. Although replacement of solvent A with solvent B has been described, the concentrating apparatus 100 in this embodiment may be exclusively used, besides solvent replacement, for concentrating the particular component.

According to this embodiment, the particular component can be concentrated and solvent-replaced with a convenient structure. Thus, in a subsequent process such as MALDI-TOFMS, a sample with a higher concentration can be used to effect an accurate inspection or an efficient reaction.

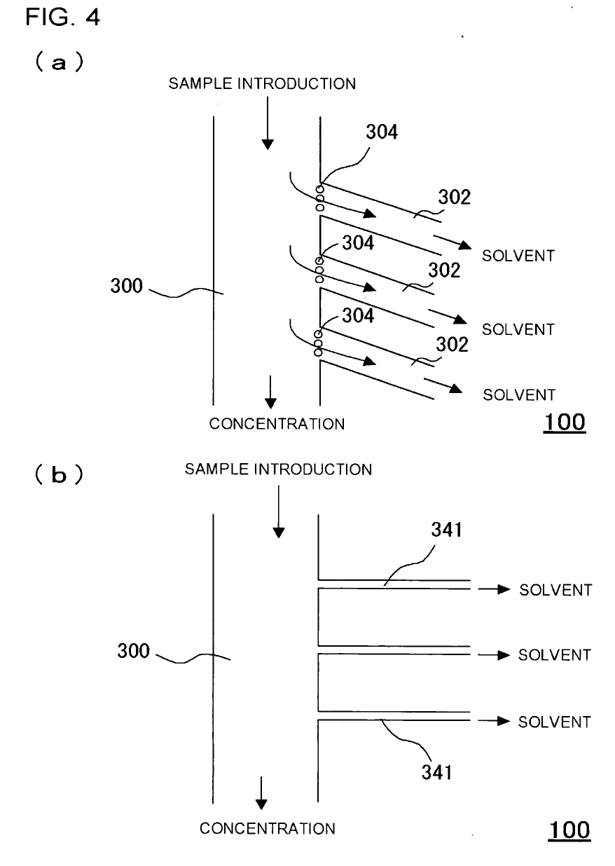

FIG. 4 shows another example of the concentrating apparatus 100 described in first and second embodiments.

As shown in FIG. 4(a), the sample feeding channel 300 may have a configuration that the sidewall includes a plurality of filtrate discharge channels 302. Herein, there is provided a filter 304 in the inlet of the filtrate discharge channel 302, to flow only a solvent in a sample introduced into the sample feeding channel 300 to the filtrate discharge channel 302. Thus, as the sample passes through the sample feeding channel 300, the sample is gradually concentrated and finally a highly concentrated sample can be recovered.

As shown in FIG. 4(b), the sample feeding channel 300 may have a configuration that the sidewall includes a plurality of capillaries 341. Again, as shown in FIG. 4(a), only a solvent in a sample introduced into the sample feeding channel 300 passes through the capillaries 341 and then discharged. Thus, as the sample passes through the sample feeding channel 300, the sample is gradually concentrated and finally a highly concentrated sample can be recovered.

### THIRD EMBODIMENT

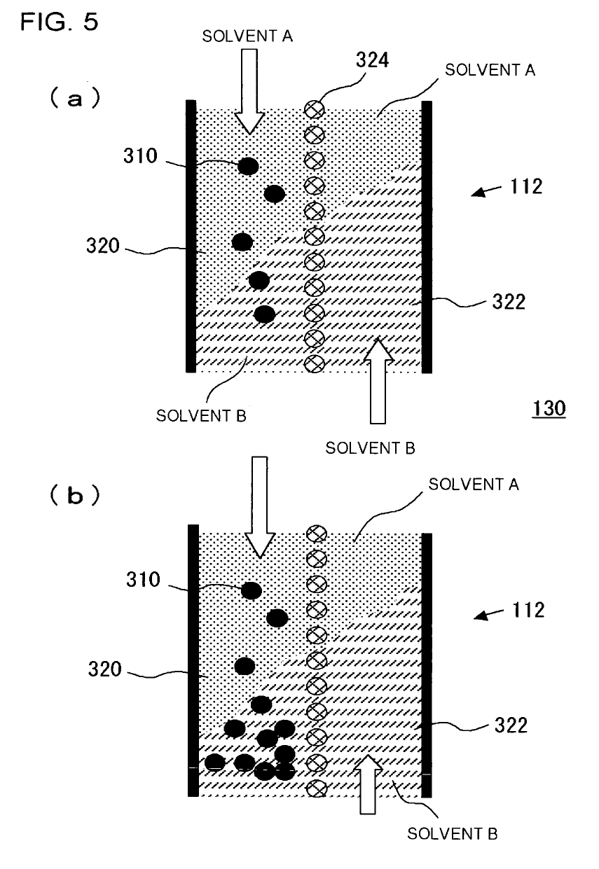

FIG. 5 shows a structure of a solvent-replacing apparatus 130 in third embodiment of this invention. In this embodiment, the solvent-replacing apparatus 130 may be a microchip. As shown in FIG. 5(a), in this embodiment, a channel 112 includes a filter 324 in the flow direction, whereby the channel is branched into a first-solvent channel 320 and a second-solvent channel 322. The filter 324 has pores with an adequately small size to prevent passage of a particular component.

The filter 324 may be a porous film prepared by firing aluminum oxide, an aqueous solution of sodium silicate (water glass) or colloidal particles, a polymer gel film prepared by gelling a polymer sol, or a number of pillars. A number of pillars may be formed as described in first embodiment with reference to FIGS. 13 to 15.

A sample containing solvent A and a particular component is introduced into the first solvent channel 320 in the solvent-replacing apparatus 130 thus constructed while replacing solvent B is introduced into the second solvent channel 322. Herein, the sample and solvent B are countercurrently introduced from the two opposed ends of the channel 112.

Here, the solvent-replacing apparatus 130 may further include external force applying means for applying an external force to a sample introduced into the first solvent channel 320 and the second solvent channel 322. The external force applying means may be a pump which may be provided independently of the first solvent channel 320 and the second solvent channel 322. Thus, a sample in each channel may countercurrently flow and an external force applied to the sample may be changed.

Thus, as each of solvents A and B diffuses, an abundance ratio of solvent A to B in the channel 112 becomes as shown in FIG. 5(a). That is, solvent A is substantially predominant near the sample inlet in the upper side of the figure while solvent B is substantially predominant near the replacing solvent inlet in the lower side of the figure. Here, as the component 310 in the sample moves in the first solvent channel 320, a concentration of solvent B in the first solvent channel 320 is increased. Since the channel 112 include the filter 324, the component 310 does not pass through the filter 324, but moves in the first solvent channel 320 downward in this figure. Thus, the component 310 can be gradually surrounded by solvent B, finally resulting in solvent replacement.

Here, when a feeding pressure for the sample is higher than a feeding pressure for solvent B, as shown in FIG. 5(b), a travel speed of the component 310 in the first solvent channel 320 may be increased so that a particular component in the sample may be concentrated and recovered. Again, as with the case shown in FIG. 5(a), an abundance of solvent B is increased in the downward direction in the figure, so that a solvent can be replaced.

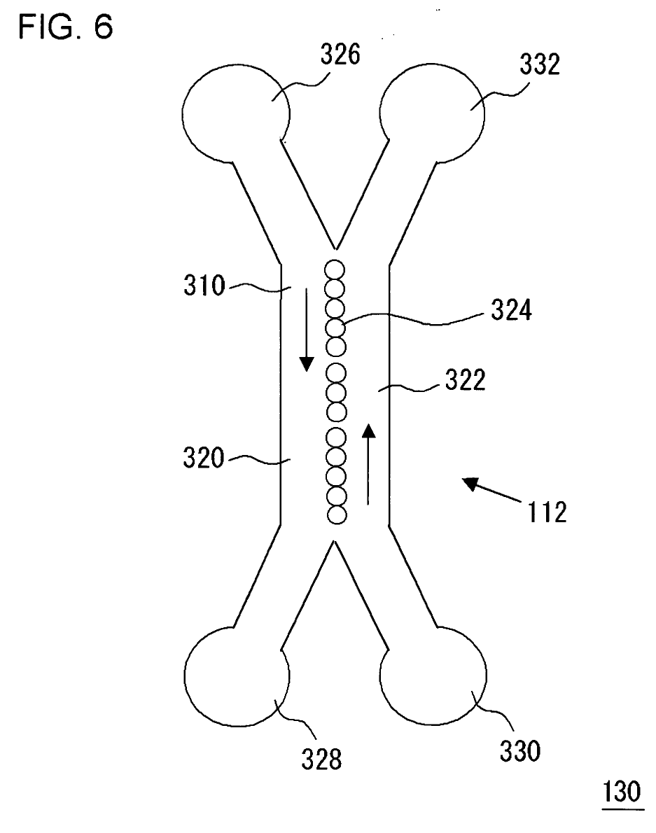

FIG. 6 schematically shows the structure of the solvent-replacing apparatus 130 in this embodiment. The first solvent channel 320 includes a sample feeding part 326 and a sample recovering part 328 in the upper and the lower sides of this figure, respectively. The second solvent channel 322 includes a solvent discharging part 332 and a solvent feeding part 330 in the upper and the lower sides of this figure, respectively. As described with reference to FIG. 5, when solvent A and the component 310 are introduced from the sample feeding part 326 and solvent B is introduced from the replacing solvent feeding part 330 as a counter flow, an abundance of solvent B is gradually increased in the first solvent channel 320 as the component 310 moves in first solvent channel 320 to the sample recovering part 328. Thus, the component 310 can be recovered as is in solvent B in the sample recovering part 328.

In this embodiment, a simpler structure may be employed to replace a solvent and concentrate a particular component. Furthermore, since the filter 324 is formed along the flow direction of the channel 112, clogging with the component in the sample may be advantageously minimized. In addition, since a solvent is replaced as the component in the sample moves in the first solvent channel 320, the component can be washed with a solvent after replacement and can be also desalted.

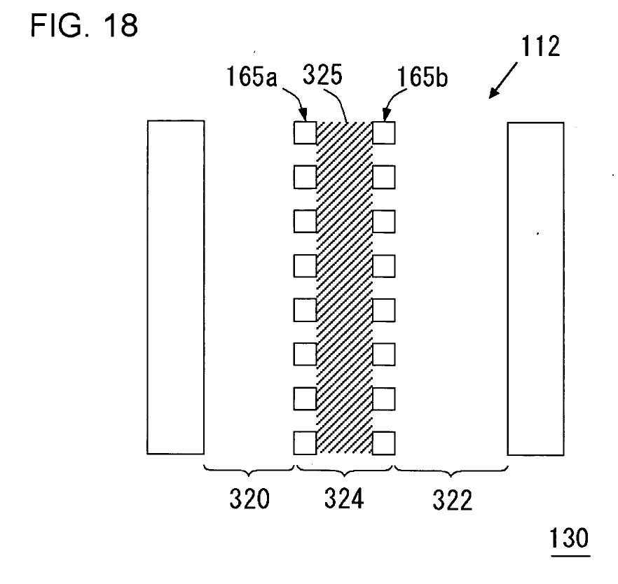

With reference to FIG. 18, there will be described an example of the use of a polymer gel film 325 as the filter 324 in this embodiment. Here, the channel 112 in the solvent-replacing apparatus 130 is divided by the septa 165a and 165b into the first solvent channel 320 and the second solvent channel 322. The polymer gel film 325 is disposed between the septa 165a and 165b. Herein, the polymer gel film 325 has a number of pores with a size of 1 nm. Current nanomachining technique cannot form pores with a size of 1 nm. Therefore, in the solvent-replacing apparatus 130 in this embodiment, the pores in the polymer gel film 325 are utilized as the filter communicating to the first solvent channel 320 and the second solvent channel 322.

Using the filter 324 thus formed, materials having a size of 1 nm or less in the sample can pass through the polymer gel film 325. Thus, it can prevent a component with a size of more than 1 nm from passing through the filter 324 to the second solvent channel 322.

The polymer gel film 325 can be prepared as follows. A given concentration of polymer sol is poured between the septa 165a and 165b. Here, the septa 165a and 165b are not covered with a coating while the remaining area is covered with a hydrophobic coating. Thus, the polymer sol remains in the second solvent channel 322 without overflowing into the first solvent channel 320 or the second solvent channel 322. By leaving in this state, the polymer sol is gelated to form the polymer gel film 325. Examples of a polymer gel include polyacrylamide, methylcellulose and agarose.

The separator of this embodiment allows a small protein with a size of, for example, about 1 nm to be concentrated. Even if a further smaller size of pores are available by nanomachining technique, the polymer gel film 325 may be used to utilize a further smaller size of pores as a filter.

Porous materials other than the polymer gel film 325 may be used, including a porous film prepared by firing an aqueous solution of sodium silicate (water glass) or a porous film prepared by firing colloidal particles such as an aluminum hydroxide sol and an iron hydroxide colloid sol.

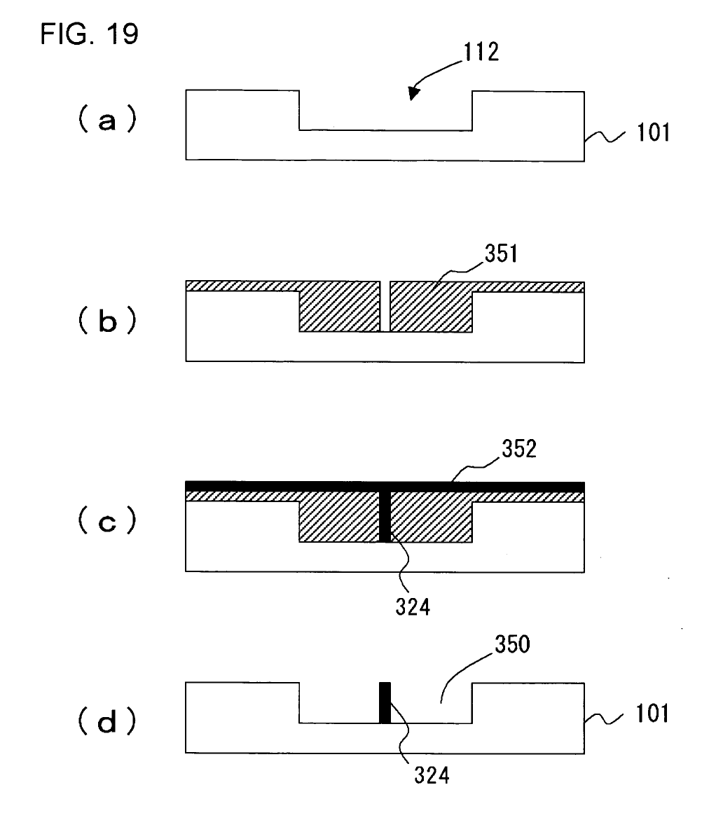

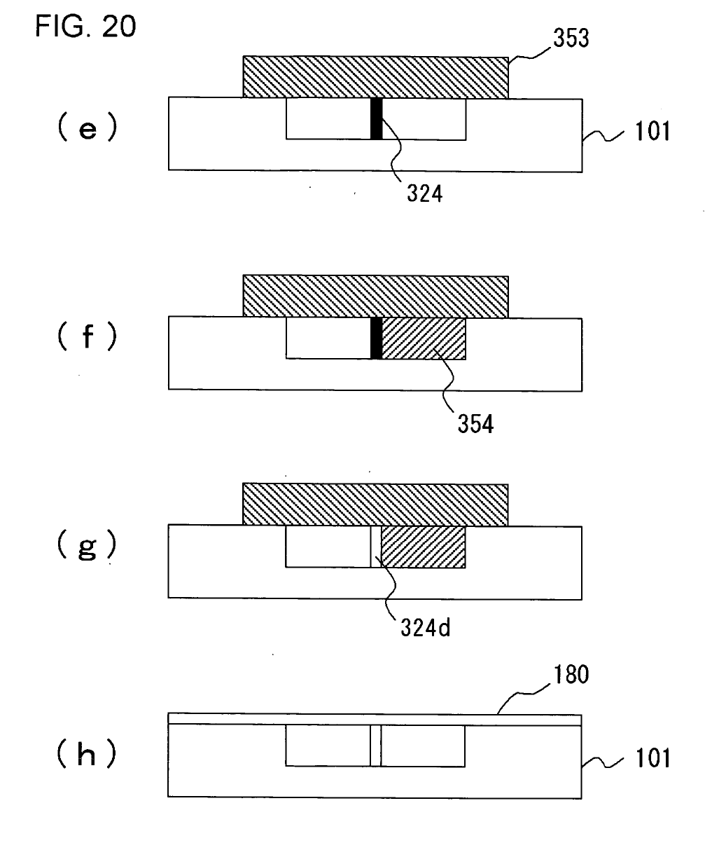

Alternatively, a filter having pores with a size of several nanometers may be formed by the following procedure which will be described with reference to FIGS. 19 and 20. First, as shown in FIG. 19(a), a channel 112 is formed in an insulating substrate 101 such as a glass and quartz. Then, as shown in FIG. 19(b), a photoresist pattern 351 having an opening in the center of the channel 112 is formed, and then as shown in FIG. 19(c), aluminum is deposited by, for example, vapor deposition to form a filter 324 and an aluminum layer 352 with a thickness of several micrometers. Subsequently, the aluminum layer 352 and the photoresist pattern 351 are removed to provide the substrate 101 with the aluminum filter 324 in the channel 112 as shown in FIG. 19(d). A height of the filter 324 is the same as the depth of the channel 112.

Next, as shown in FIG. 20(e), the electrode 353 is contacted with the filter 324 while being pressed against the substrate 101 along the flow direction in the channel 112. Then, as shown in FIG. 20(f), an electrolyte solution 354 such as sulfuric acid is introduced into one channel and an electrode is disposed at the end of the channel such that it is immersed in the electrolyte solution. Using the electrode 353 as an anode and the electrode at the end of the channel as a cathode, a voltage is applied to effect anodic oxidation. The oxidation is continued until a current is ceased. As a result, a filter 324d made of an aluminum oxide is obtained as shown in FIG. 20(g). Then, hydrochloric acid is introduced into the other channel to dissolve and remove the remaining unoxidized aluminum. Then, as shown in FIG. 20(h), a coating 180 is formed over the substrate 101 to provide a separator.

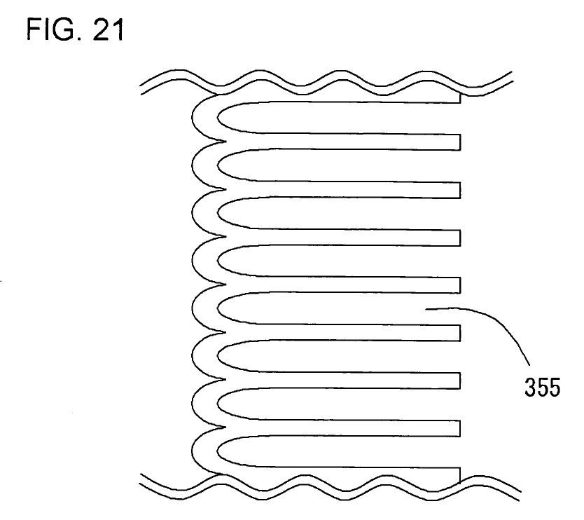

FIG. 21 shows an enlarged view of the filter 324d made of an aluminum oxide in FIG. 20(g). As shown in this figure, the septum is an aluminum oxide film in which tubular concaves 355 are regularly formed. The aluminum oxide film has a lattice with apertures of about 0.1 nm and, therefore, only ions can pass through the film. Thus, even a protein with a very small size can be concentrated.

Although anodic oxidation has been conducted while introducing the electrolyte solution 354 only in one channel as shown in FIG. 20(f) in the above description, anodic oxidation may be effected while introducing an electrolyte solution into both channels to form penetrating pores in the septum. Since the penetrating pores thus formed have a size of 1 to 4 nm, a separator including such a septum may be suitably used for concentrating a protein.

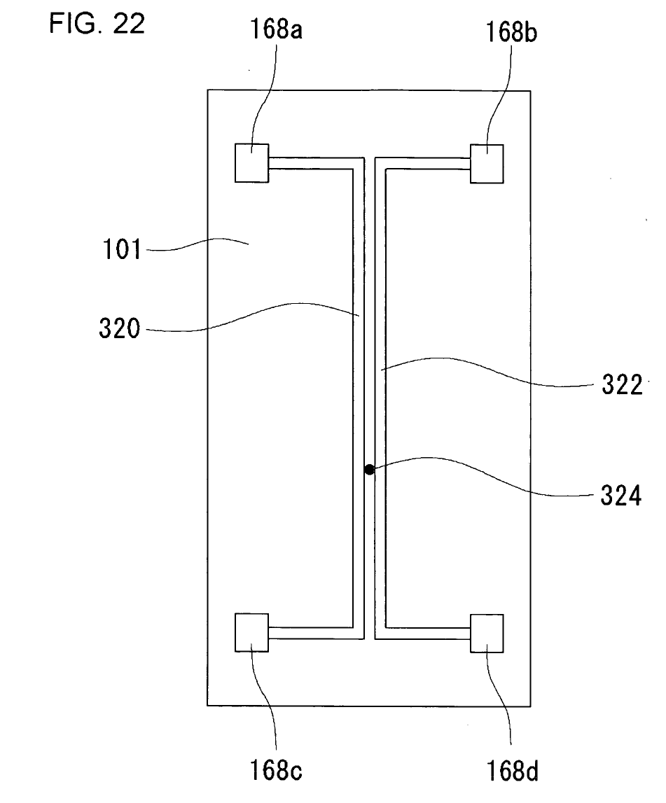

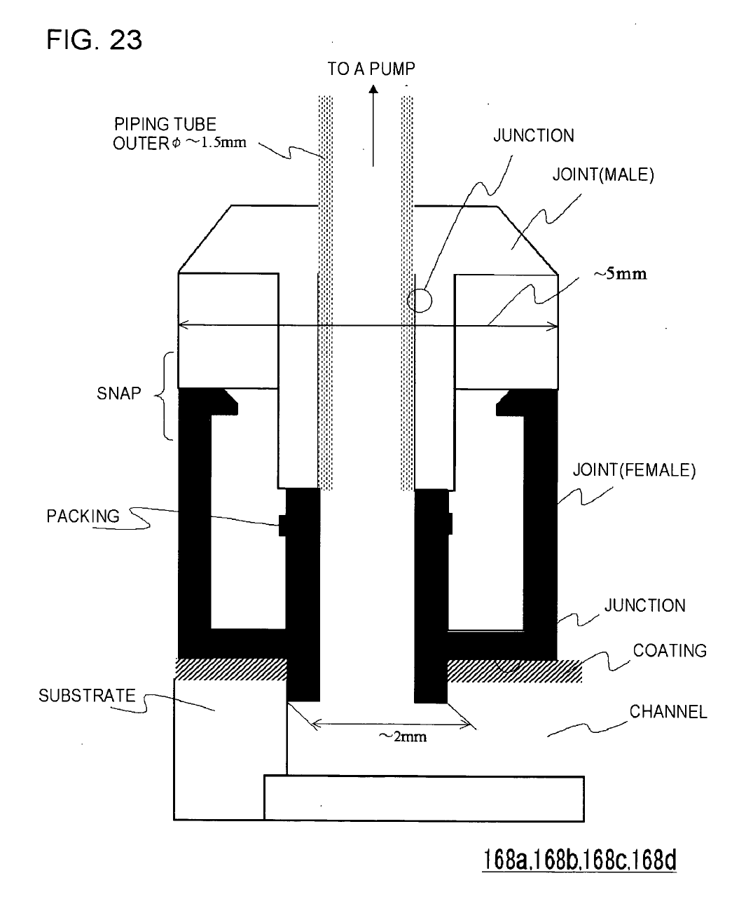

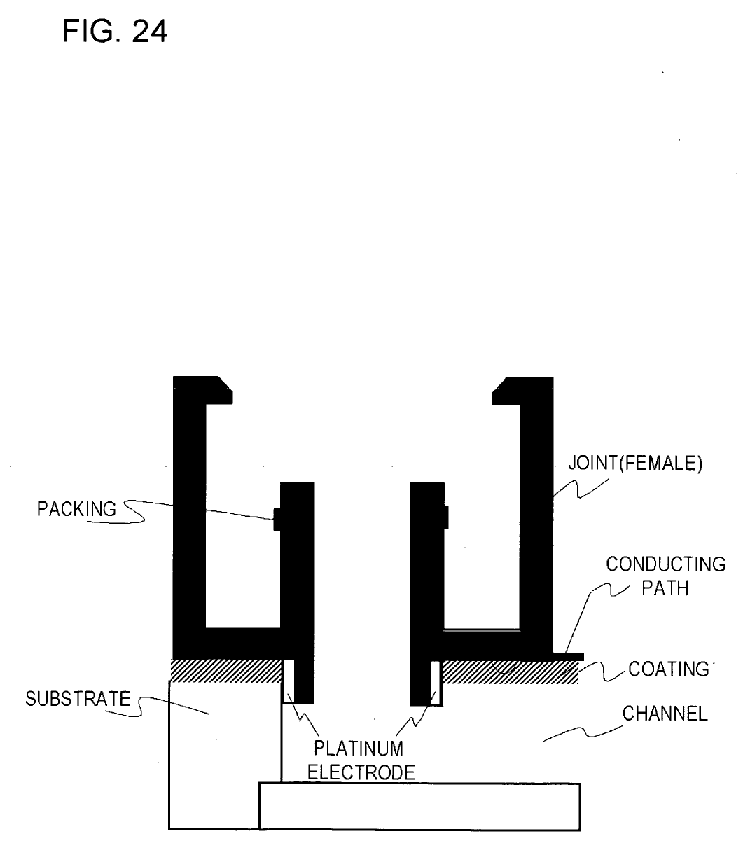

FIG. 22 schematically shows a structure of a solvent-replacing apparatus 130 according to this invention as a microchip. The apparatus has a structure where on a substrate 101 are formed a first solvent channel 320 and a second solvent channel 322, between which a filter 324 intervenes. The filter 324 has a number of pores at given intervals. At both ends of the first solvent channel 320 and the second solvent channel 322, there are provided joints 168a to 168d having the shape shown in FIG. 23, via which a pump is connected (not shown). The pump applies an external force to a solvent in the first solvent channel 320 and the second solvent channel 322 to move it in a given direction. Although in this embodiment, a pump is used as external force applying means for moving the solvent or a component in the solvent, another type of external force applying means may be of course used. For example, a voltage may be applied to the channel, where joints may have the structure shown in FIG. 24.

FIG. 25 is a detailed drawing of the filter 324 in the solvent-replacing apparatus 130 having the configuration shown in FIG. 22, where on a substrate 101 are formed a first solvent channel 320 and a second solvent channel 322, between which a filter 324 intervenes.

### FOURTH EMBODIMENT

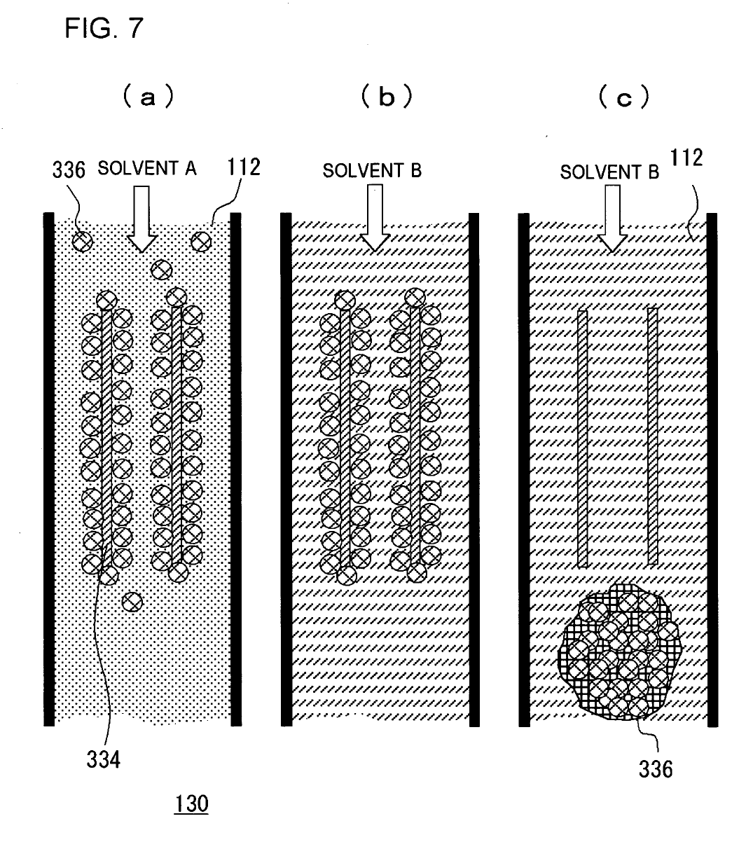

FIG. 7 shows a structure of a solvent-replacing apparatus 130 in fourth embodiment of this invention. This may be effectively used when a particular component to be concentrated carries an electric charge. Again, in this embodiment, the solvent-replacing apparatus 130 may be a microchip.

The channel 112 includes an electrode 334. The electrode 334 has an electric charge opposite to that of the particular component 336 to be concentrated. For example, when protein or DNA molecules are to be concentrated, these molecules generally have a negative charge. Therefore, herein, the electrode 334 is positively charged while a sample is fed to the channel 112. Thus, as shown in FIG. 7(a), the component 336 in the sample adheres to the surface of the electrode 334 and solvent A flows in the channel 112. Thus, the component 336 can be concentrated on the surface of the electrode 334 near the electrode 334.

Next, as shown in FIG. 7(b), solvent B is fed. Here, the electrode 334 may be maintained in being positively charged to wash out only solvent A and other undesired components adhering to the surface of the component 336 while the component 336 still adheres to the surface of the electrode 334.

After thoroughly washing with solvent B, as shown in FIG. 7(c), application of a voltage to the electrode 334 is stopped or reversed to allow the component 336 adhering to the electrode 334 to be released and then discharged from the channel 112.

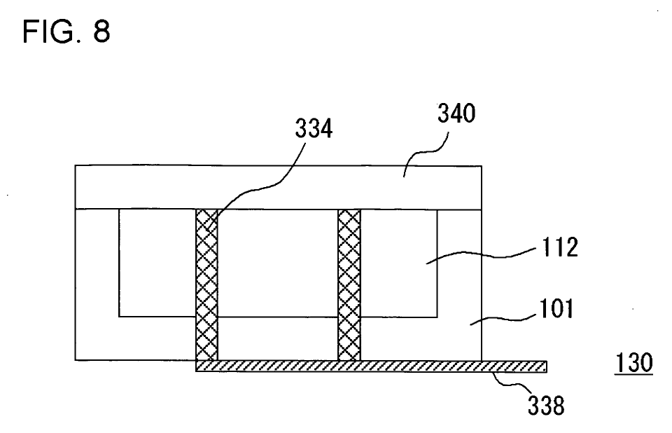

FIG. 8 is a cross-sectional view of the solvent-replacing apparatus 130 shown in FIG. 7. The electrode 334 is connected to an interconnection 338 provided on the rear surface of the substrate 101, whereby a voltage can be applied. The solvent-replacing apparatus 130 includes a coating material 340.

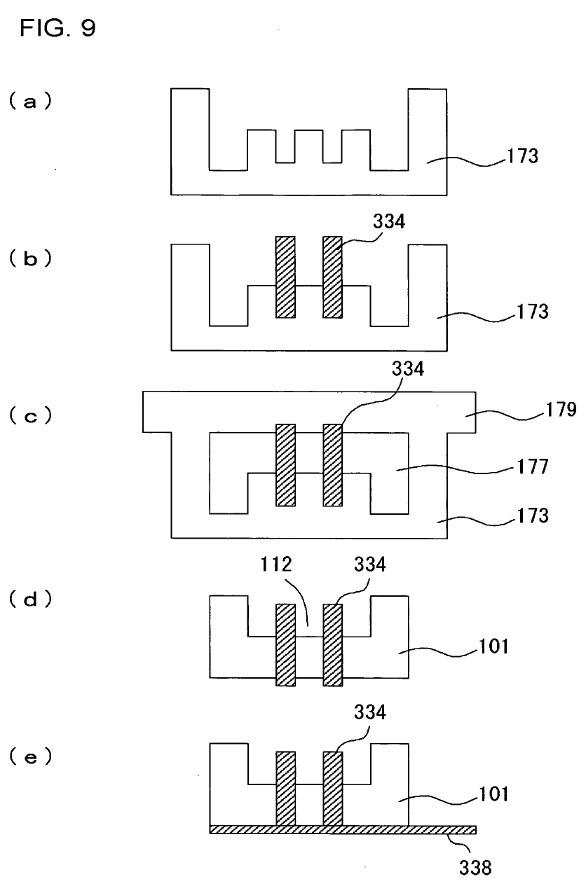

In this embodiment, the electrode 334 may be prepared by, for example, the procedure described below. FIG. 9 is a process cross-sectional view illustrating a process for manufacturing the solvent-replacing apparatus 130 in this embodiment. First, a mold 173 including an area for mounting an electrode is prepared (FIG. 9(a)). Then, an electrode 334 is mounted to the mold 173 (FIG. 9(b)). The electrode 334 may be made of, for example, Au, Pt, Ag, Al or Cu. Next, a cover mold 179 is placed on the mold 173 to fix the electrode 334. Then, a resin 177 to be a substrate 101 is injected into the mold 173 and molded (FIG. 9(c)). The resin 177 may be, for example, PMMA.

The molded resin 177 thus formed is released from the mold and the cover mold 179, to give a substrate 101 having a channel 112 (FIG. 9(d)). The impurities on the surface of the electrode 334 are removed by ashing to expose the electrode 334 on the rear surface of the substrate 101. Then, a metal film is vapor-deposited on the rear surface of the substrate 101 to form an interconnection 338 (FIG. 9(e)). Thus, the electrode 334 can be formed in the channel 112. The electrode or the interconnection 338 thus formed is connected to an external power source (not shown) for applying a voltage.

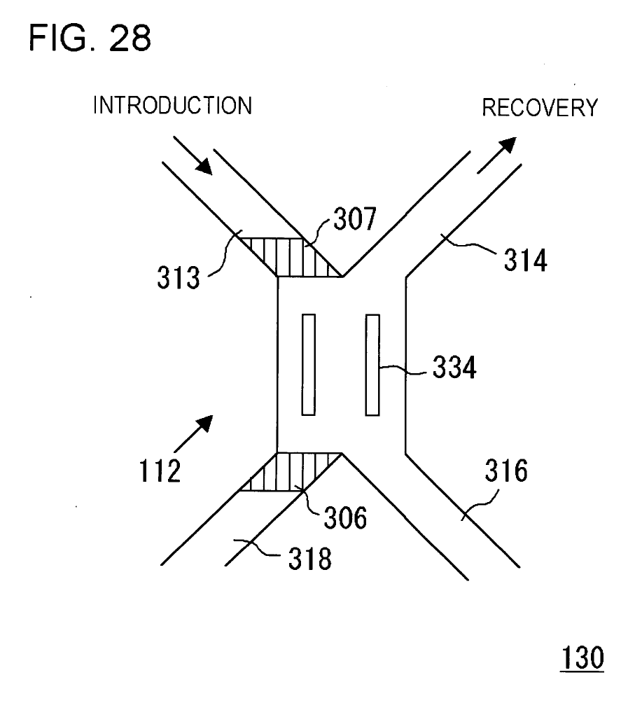

As described in second embodiment, the electrode 334 may be provided in the channel shown in FIG. 28. It can prevent various solvents and other components from being mixed and allow for accurate concentration and solvent-replacement.

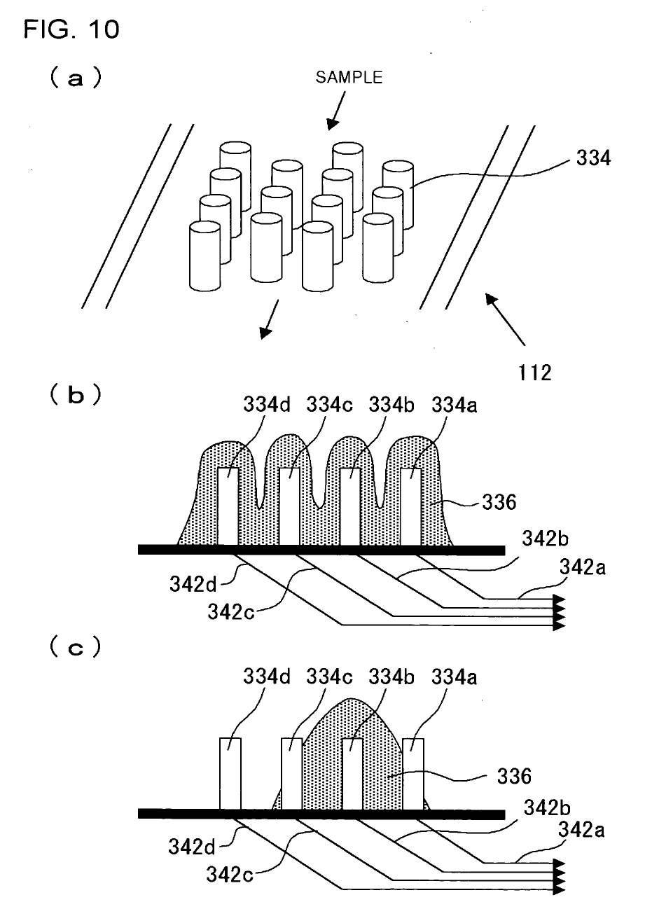

The electrode 334 formed in the channel 112 may include a plurality of pillars shown in FIG. 10. FIG. 10(a) is a perspective view of the channel 112 and FIG. 10(b) and FIG. 10(c) are cross-sectional views thereof. Again, the electrode 334 may be formed as described above. When the electrode 334 is included of a plurality of pillars, a surface area may be increased, so that many molecules of the component 336 can adhere to the surface of the electrode 334. As shown in FIGS. 10(b) and 10(c), the electrodes 334a to 334d are connected to interconnections 342a to 342d, respectively. Thus, the plurality of electrodes 334a to 334d are independently controlled. First, as shown in FIG. 10(b), all of the electrodes 334a to 334d are electrically charged with an opposite polarity to the component 336 to allow many molecules of the component 336 to adhere to the surfaces of the electrodes 334a to 334d. Then, as shown in FIG. 10(c), for example, only the electrode 334b is electrically charged with an opposite polarity to the component 310 while the other electrodes 334a, 334c and 334d are charged with the same polarity as the component 310. Thus, all molecules of the component 310 adhering to these electrodes 334a to 334d gather to the electrode 334b, so that the component 336 can be concentrated to a further higher concentration.

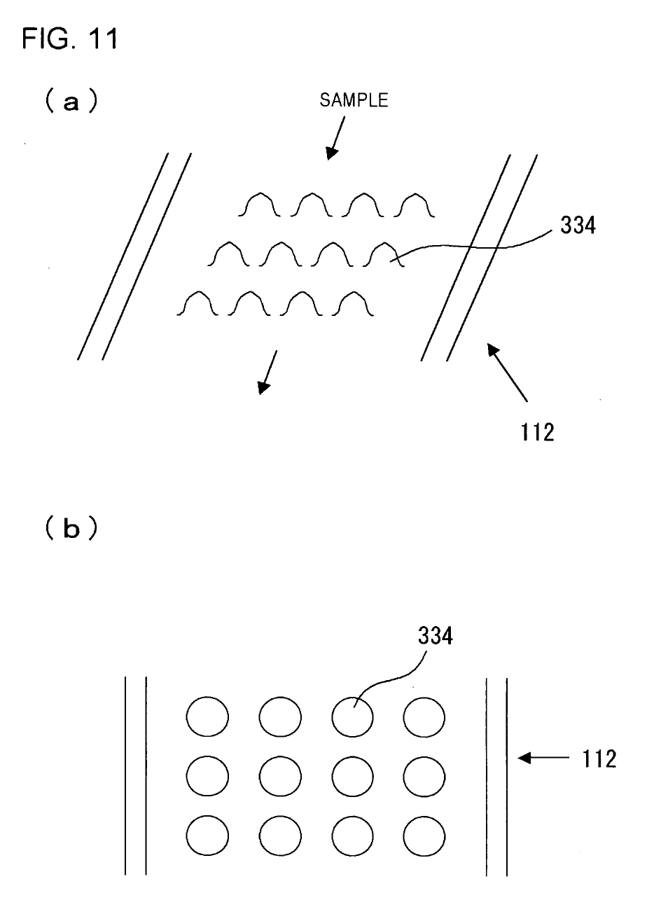

Alternatively, the electrode 334 formed in the channel 112 may be composed of a plurality of gently-sloping mountain-like protrusions as shown in FIG. 11. FIGS. 11(a) and 11(b) are a perspective view and a plan view of the channel 112, respectively. Such a configuration is preferable because interaction between adjacent electrodes can be reduced and the component 336 can be efficiently recovered on each electrode.

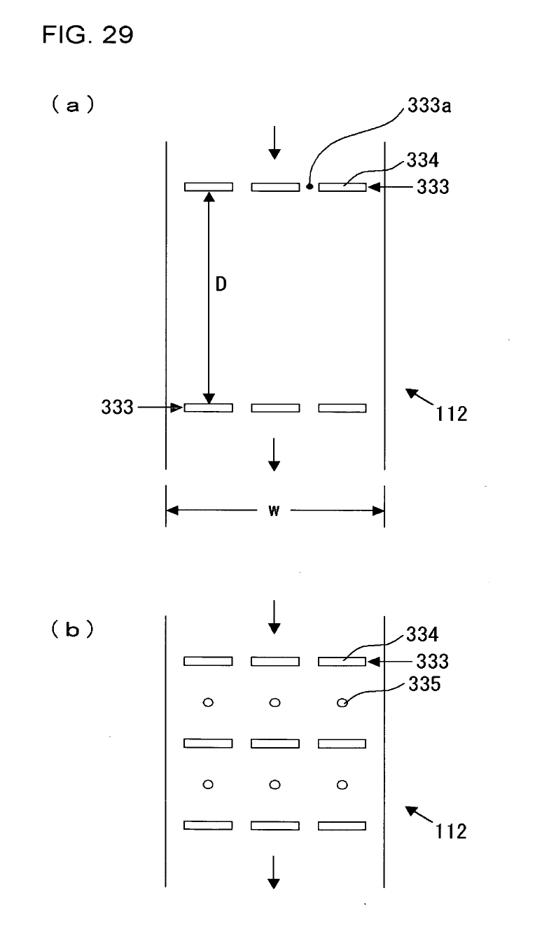

The electrode 334 may be disposed as shown in FIG. 29. As shown in FIG. 29(a), a plurality of electrode plates 333 having apertures 333a through which a sample can pass, with an interval of D in the flow direction in the channel 112. Here, the individual electrode plates 333 are placed such that the interval D is larger than the width W of the channel 112, more preferably at least twice as large as the width of the channel 112. Such a configuration can prevent a phenomenon that the sample cannot enter between the electrodes 333 due to influence of an electric flux line between the electrodes 334. The apertures 333a formed in the electrode plate 333 has an enough size to allow the sample to pass through them. Alternatively, as shown in FIG. 29(b), counter electrodes 335 to the electrodes 334 may be disposed between the electrodes 334 electrically charged with an opposite polarity to the sample. Thus, the sample moves toward any of the electrodes 334 disposed in both sides of the counter electrodes 335, so that the amount of the sample adhering to the electrodes 334 can be increased.

Again, in this embodiment, while the particular component is concentrated by adhering to the surface of the electrode 334, a solvent can be replaced. Furthermore, since the particular component adhering to the electrode 334 can be washed with a replacing solvent, it may be desalted.

The concentrating apparatuses and the solvent-replacing apparatuses described in the above embodiments can be used in pretreatment for MALDI-TOFMS. There will be described, as an example, preparation and measurement of a protein sample for MALDI-TOFMS.

For obtaining detailed data of a protein to be measured by MALDI-TOFMS, a molecular weight of the protein must be reduced to about 1000 Da.

When the target protein has an intramolecular disulfide bond, the sample is subjected to reduction in a solvent such as acetonitrile containing a reducing agent such as DTT (dithiothreitol). Thus, a next decomposition reaction can efficiently proceed. It is preferable that after reduction, a thiol group is protected by, for example, alkylation to prevent re-oxidation. The microchip in this embodiment can be used for replacing a solvent such as acetonitrile with a phosphate buffer, distilled water or the like after such a reaction.

Next, the reduced protein molecule is subjected to molecular weight reduction using a protein hydrolase such as trypsin. Since molecular weight reduction is conducted in a buffer such as a phosphate buffer, appropriate treatment such as removal of trypsin and desalting is conducted after the reaction. Then, the protein molecule is mixed with a matrix for MALDI-TOFMS and the mixture is dried.

A MALDI-TOFMS matrix may be appropriately selected, depending on a material to be measured. Examples of a matrix which can be used include sinapic acid, α-CHCA α-cyano-4-hydroxycinnamic acid), 2,5-DHB (2,5-dihydroxybenzoic acid), a mixture of 2,5-DHB and DHBs (5-methoxysalicylic acid), HABA (2-(4-hydroxyphenylazo) benzoic acid), 3-HPA (3-hydroxypicolinic acid), dithranol, THAP (2,4,6-trihydroxyacetophenone), IAA (trans-3-indoleacrylic acid), picolinic acid and nicotinic acid.

The microchip in this embodiment may be formed on a substrate, where, for example, a separator and a drying apparatus can be formed in the upstream and the downstream sides, respectively, permitting the substrate to be set in an MALDI-TOFMS apparatus as it is. Thus, separation, pretreatment, drying and structural analysis of a desired particular component can be effected on one substrate.

The dried sample is set in the MALDI-TOFMS apparatus, applied with a voltage and irradiated with, for example, nitrogen laser beam at 337 nm to be analyzed by MALDI-TOFMS.

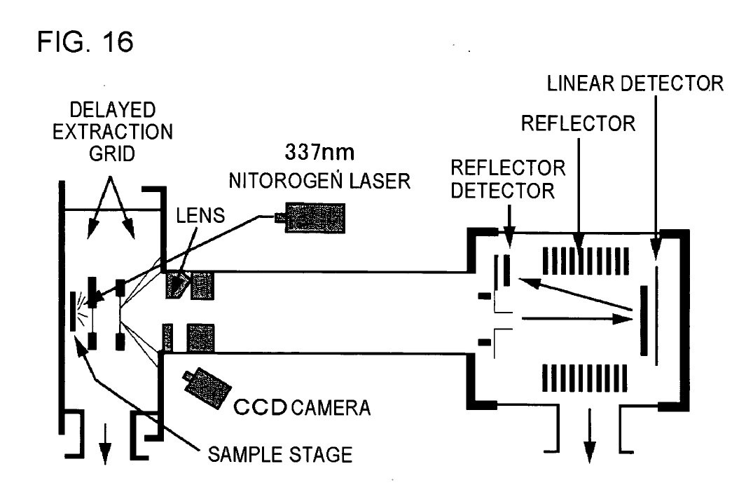

There will be briefly described a mass spectrometer used in this embodiment. FIG. 16 schematically illustrates a configuration of the mass spectrometer. In FIG. 16, the dried sample is set on a sample stage. Then, the dried sample is irradiated with a nitrogen gas laser at a wavelength of 337 nm in vacuo, to vaporize the dried sample together with the matrix. By applying a voltage using the sample stage as an electrode, the vaporized sample travels in the vacuum atmosphere and detected by a detection unit including a reflector detector, a reflector and a linear detector.

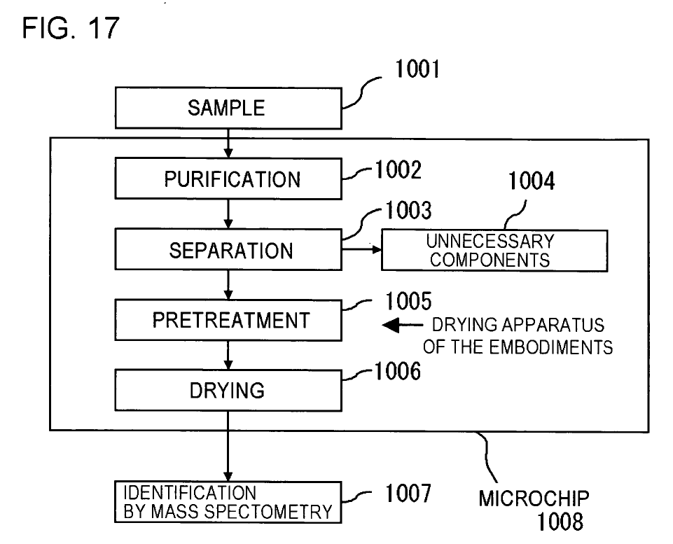

FIG. 17 is a block diagram showing a mass spectrometry system including the concentrating apparatus or the solvent-replacing apparatus in this embodiment. The system includes means for effecting the steps of purification 1002 of a sample 1001 for removing contaminants to some extent, separation 1003 for removing unnecessary components 1004, pretreatment 1005 of the separated sample and drying 1006 of the pretreated sample. After these steps, identification 1007 is conducted by mass spectrometry. The steps from purification 1002 to drying 1006 may be effected on one microchip 1008.

The microchip of this embodiment corresponds to the means conducting a part of the step of pretreatment 1005.

Thus, in the mass spectrometry system of this embodiment, even a trace amount of component can be efficiently and reliably identified with a reduced loss by continuously treating a sample on one microchip 1008.

This invention has been described with reference to some embodiments. It will be understood by the skilled in the art that these embodiments are only illustrative and that there may be many variations for a combination of the components and the manufacturing process, which are encompassed by the present invention.

The filter 304 in first and second embodiments may be also a porous film prepared by firing an aluminum oxide, an aqueous solution of sodium silicate (water glass) or colloidal particles or a polymer gel prepared by gelating a polymer sol as described in third embodiment.

### EXAMPLE

An example of this invention will be described.

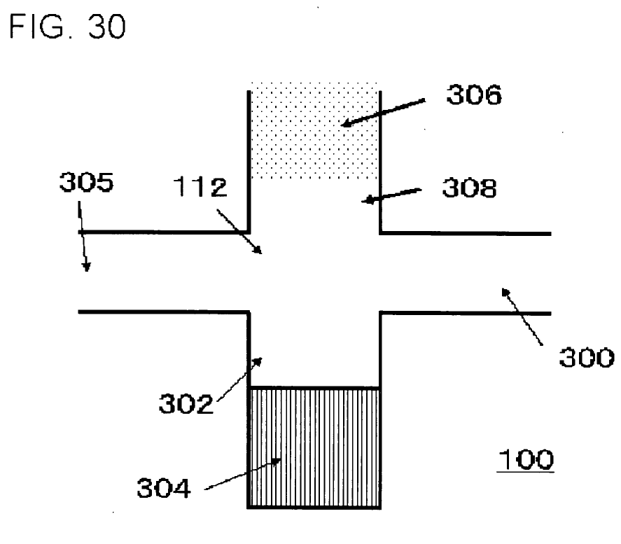

In this example, a concentrating/replacing apparatus having the structure shown in FIG. 30 on a chip 100 was prepared and evaluated. The channel 112 was covered by a glass lid. A filter 304 consisting of pillars was disposed between a sample feeding channel 300 and a filtrate discharge channel 302. In addition, a waste channel 305 was provided for discharging an excessive solution. A sample recovering part 308 was hydrophobilized with silazane.

In this example, the pillars were formed by the machining process described in first embodiment. The sample feeding channel 300 and the waste channel 305 had a width of 40 μm, the filtrate discharge channel 302 and the sample recovering part 308 had a width of 80 μm, and the channel 112 had a depth of 400 nm.

FIG. 31 is a scanning electron microscopy image of the pillars 105 formed as the filter 304, where strips with a width of 3 μm are aligned with a pitch of 700 nm and an interval between strip lanes is 1 μm.

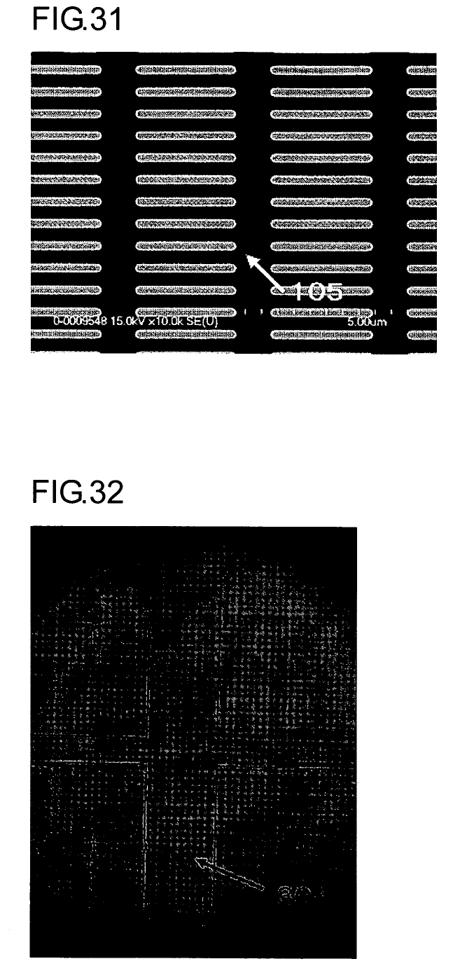

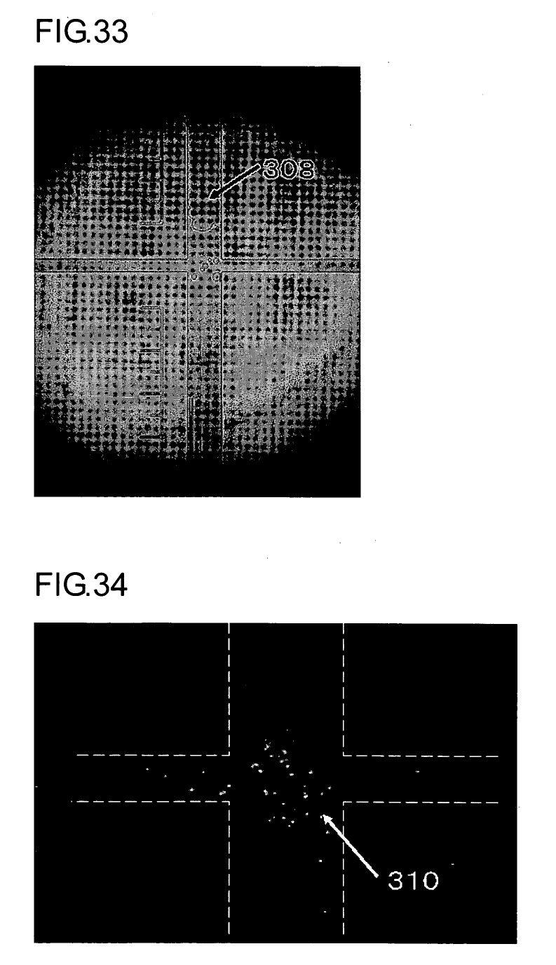

FIG. 32 shows the concentrating/replacing apparatus of this example (an optical microscope image). FIG. 33 shows a concentrating/replacing apparatus to which water is introduced utilizing capillary action. Water does not enter the sample recovering part treated with silazane.

In this example, the concentrating/replacing apparatus was used to concentrate and solvent-replace a DNA as described below.

Water containing a DNA (9.6 kbp) stained with a fluorescent dye was introduced into the sample feeding channel 300. FIG. 34 is a fluorescence microscopy image showing inflow of water containing a DNA. The DNA does not exist in the silazane-treated sample recovering part (channel) 308. Furthermore, since an interval between the pillars is narrow, the DNA is deposited on the filter 304 and the filter is gradually clogged, so that it becomes difficult for water to enter the filtrate discharge channel 302. Therefore, an excessive water containing the DNA is guided to the waste channel 305. Then, ethanol was introduced into the sample feeding channel 300.

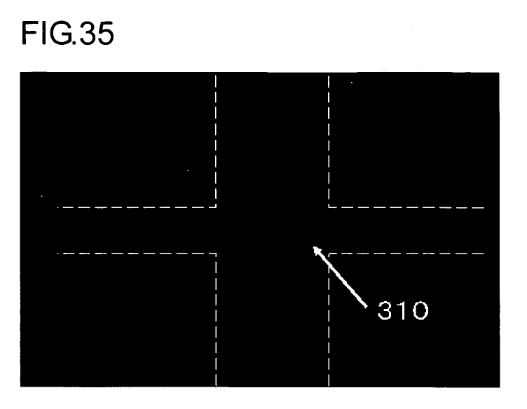

FIG. 35 is a fluorescence microscopy image showing travelling of the DNA with ethanol flowing in the channel 112. Ethanol flows in the silazane-treated sample recovering part 308 and the channel in the sample recovering part 308 is wider than the waste channel 305. Therefore, the DNA deposited and concentrated on the filter was preferentially introduced into the sample recovering part 308 and then leaked to the outlet of the sample recovering channel. The substrate was placed on an ultrasonic vibrator to fragmentate the DNA. Then, the sample was dried for spontaneously evaporating the solvent. Then, several microliters of a matrix was added dropwise to the DNA which leaked to the outlet of the sample recovering channel, and then the sample was analyzed by MALDI-TOFMS. Thus, the analysis results for the DNA were obtained.

As shown above, this example indicated that a concentrating/replacing apparatus capable of concentrating and solvent-replacing a DNA was obtained.

As described above, this invention can provide a technique for concentrating and recovering a particular component in a sample with a higher concentration. This invention also provides a technique for replacing a solvent while keeping a particular component in a sample concentrated. This invention also provides a technique for removing undesired components such as salts in a sample while maintaining a particular component in the sample concentrated. This invention also provides a technique for effecting these processes on a microchip.

1. A microchip on a substrate, comprising a channel for a liquid sample containing a particular component and a sample feeding part provided in said channel,
wherein said channel is branched into a first channel and a second channel, an inlet of said first channel from said sample feeding part has a filter for preventing passage of said particular component, and an inlet of said second channel from said sample feeding part has a damming area preventing passage of said liquid sample while permitting said liquid sample to pass when an external force equal to or larger than a given level is applied.

2. The microchip as claimed in claim 1, wherein said damming area is a lyophobic area.

3. The microchip as claimed in claim 1, wherein said liquid sample which has passed through said filter moves by capillary action.

4. The microchip as claimed in claim 1, wherein said first channel further comprises an inflow stopper downstream of said filter for preventing a liquid from flowing into said first channel.

5. The microchip as claimed in claim 4, wherein said inflow stopper prevents a liquid from flowing into said first channel when a predetermined amount of liquid enters said first channel.

6. The microchip as claimed in claim 4, further comprising external force applying means for applying an external force to a liquid sample flowing said channel,
wherein said external force applying means applies an external force to a sample such that when inflow of a liquid into said first channel is stopped by said inflow stopper, said liquid sample flows over said lyophobic area into said second channel.

7. The microchip as claimed in claim 1, wherein said filter is comprised of a plurality of pillars.

8. The microchip as claimed in claim 1, wherein said filter is an aluminum oxide, a porous film or a polymer gel film.

9. A microchip on a substrate, comprising a channel for a liquid sample containing a particular component and a plurality of discharge channels along the sidewall of said channel, wherein said discharge channels prevent passage of said particular component.

10. A microchip on a substrate, comprising a channel for a liquid sample containing a particular component and a filter disposed to block the flow in said channel for preventing passage of said particular component, wherein said channel comprises a branched part consisting of a sample feeding part and a sample recovering part in one side and a solvent feeding part in the other side.

11. The microchip as claimed in claim 10, further comprising a discharging part disposed at a position other than said solvent feeding part in the other side of said filter, from which said liquid sample passing through said filter is discharged.

12. The microchip as claimed in claim 11, wherein said liquid sample passing through said filter moves by capillary action.

13. The microchip as claimed in claim 10, wherein said solvent feeding part comprises a damming area preventing a liquid from entering from the direction of said filter while facilitating discharge of the liquid toward said filter.

14. The microchip as claimed in claim 10, wherein said sample feeding part comprises a damming area preventing a liquid from entering from the direction of said filter while facilitating discharge of the liquid toward said filter.

15. The microchip as claimed in claim 13, wherein said damming area is a lyophobic area.

16. A microchip on a substrate, comprising a channel including a first channel in which a liquid sample containing a particular component flows and a second channel extending along said first channel, and a filter intervening between said first channel and said second channel for preventing passage of said particular component,
wherein said first channel includes a sample feeding part for introducing said liquid sample upstream in the flowing direction and said second channel comprises a substituting solvent feeding part at a position corresponding to the downstream in the flowing direction in said first channel.

17. The microchip as claimed in claim 16, further comprising an external force applying means which applies an external force to said first channel and said second channel in different directions.

18. The microchip as claimed in claim 17, wherein said external force applying means applies a larger external force to said first channel than to said second channel.

19. A microchip on a substrate, comprising a channel for a liquid sample containing a particular component and an electrode formed in said channel,
wherein said electrode has a charge having a different polarity from that of said particular component.

20. A process for concentrating a particular component in a liquid sample using said microchip as claimed in claim 1, comprising the steps of
applying an external force enough to introduce the liquid sample containing said particular component and a solvent into said sample feeding part but not enough for said liquid sample to pass through said damming area;
applying an external force comparable to that applied in said step of introducing said liquid sample to said sample feeding part to introduce said solvent or another solvent into said sample feeding part for a given period; and
stopping said flow of the liquid into said first channel.

21. The process for concentrating as claimed in claim 20, wherein in said step of stopping said flow of said liquid into said first channel, an external force larger than that in any other steps is applied.

22. A process for replacing a solvent in a liquid sample containing a particular component using said microchip as claimed in claim 1, comprising the steps of
applying an external force enough to introduce the liquid sample containing said particular component and a first solvent into said sample feeding part but not enough for said liquid sample to pass through said damming area;
applying an external force comparable to that applied in said step of introducing said liquid sample to said sample feeding part to introduce a solvent other than said first solvent into said sample feeding part for a given period; and
stopping said flow of the liquid into said first channel.

23. The process for replacing a solvent as claimed in claim 22, wherein in said step of preventing a liquid from flowing into said first channel, an external force larger than that in any other steps is applied.

24. A process for concentrating a particular component in a liquid sample using said microchip as claimed in claim 10, comprising the steps of
introducing the liquid sample containing said particular component and a solvent into said sample feeding part; and
recovering said particular component from said sample recovering part by introducing another solvent from a solvent feeding part.

25. The process for concentrating as claimed in claim 24, further comprising the step of introducing one of the solvents from said sample feeding part, between said steps of introducing said liquid sample and recovering said liquid sample.

26. A process for replacing a solvent in a liquid sample containing a particular component using said microchip as claimed in claim 10, comprising the steps of
introducing the liquid sample containing said particular component and a first solvent into said sample feeding part; and
recovering said particular component from said sample recovering part by introducing a second solvent other than said first solvent from said solvent feeding part.

27. The process for replacing a solvent as claimed in claim 26, further comprising the step of introducing said second solvent from said sample feeding part, between said steps of introducing said liquid sample and recovering said liquid sample.

28. A process for replacing a solvent in a liquid sample using a separator comprising a first channel and a second channel for a liquid sample containing a particular component and a filter intervening between said channels, comprising the step of
moving the liquid sample containing said particular component and a first solvent in said first channel in a first direction; and
simultaneously moving a second solvent in said second channel in a direction different from said first direction,
wherein a ratio of said second solvent to said first solvent increases as said liquid sample is moved in said first channel.

29. The process for replacing a solvent as claimed in claim 28, wherein an external force applied for moving said liquid sample containing said particular component and said first solvent in said first channel in said first direction is larger than an external force for moving said second solvent in said second channel in a direction different from said first direction, to concentrate said particular component in the downstream of said first channel.

30. A process for replacing a solvent in a liquid sample containing a particular component using a channel comprising an electrode, comprising the steps of
feeding the liquid sample containing said particular component and a first solvent into said channel while charging said electrode with an opposite polarity to said particular component;
feeding a second solvent into said channel while maintaining said charge of said electrode; and
discharging said electrode and recovering said particular component together with said second solvent.

31. The process for replacing a solvent as claimed in claim 30, wherein said electrode has a charge with the same polarity as said particular component in said step of recovery.

32. A mass spectrometry system comprising
pretreatment means for separating a biological sample by a molecular size or properties while pretreating said sample for preparation for enzymatic digestion;
means for enzymatically digesting said pretreated sample; drying means for drying said enzymatically digested sample; and
mass spectrometry means for analyzing said dried sample by mass spectrometry,
wherein said pretreatment means comprises said microchip as claimed in claim 1.
